(19) United States
(12) Patent Application Publication
(10) Pub. No.: US 2015/0244603 A1
(43) Pub. Date: Aug. 27, 2015

(54) DETERMINING METHOD AND SYSTEM

(71) Applicant: FUJITSU LIMITED, Kawasaki-shi (JP)

(72) Inventors: Koichiro YAMASHITA, Hachioji (JP); Takahisa SUZUKI, Yokohama (JP); Hiromasa YAMAUCHI, Usakos (NA); Toshiya OTOMO, Kawasaki (JP)

(73) Assignee: FUJITSU LIMITED, Kawasaki (JP)

(21) Appl. No.: 14/707,030

(22) Filed: May 8, 2015

Related U.S. Application Data
(63) Continuation of application No. PCT/JP2012/079191, filed on Nov. 9, 2012.

(51) Int. Cl. H04L 12/26

(52) U.S. Cl. CPC H04L 43/0876; H04L 43/04

(57) ABSTRACT

A computer obtains first information related to a first communication path that is from a first aggregating apparatus to a second aggregating apparatus when the second aggregating apparatus receives a transmission signal that is from sensor nodes in response to a transmission instruction that is transmitted by the first aggregating apparatus and propagated by multi-hop communication via the sensor nodes. The computer obtains from a storage apparatus, second information that is related to a second communication path that is a stationary path from the first aggregating apparatus to reception by the second aggregating apparatus. The computer determines correspondence of the first communication path and the second communication path by comparison of the first information and the second information, and if the first communication path and the second communication path do not correspond, the computer determines that an abnormality related to a sensor node is present.

### CROSS REFERENCE TO RELATED APPLICATIONS

This application is a continuation application of International Application PCT/JP2012/079191, filed on Nov. 9, 2012 and designating the U.S., the entire contents of which are incorporated herein by reference.

### FIELD

The embodiment discussed herein is related to a determining method and a system.

### BACKGROUND

Conventionally, sensor network systems are known in which an information processing apparatus that is a higher order computer obtains in real-time by a wireless communications means, data related to sensing by sensor nodes. For example, according to a known technique, in a sensor network system, sensor data is cyclically updated and saved, and abnormalities in measurement data are detected (for example, refer to Japanese Laid-Open Patent Publication No. 2009-260778).

Further, for example, according to another known technique, in a sensor network system, abnormalities are detected by each sensor node by comparing sensing data thereof and sensing data received from another sensor node (for example, refer to Japanese Laid-Open Patent Publication No. 2007-300499).

According to yet another known technique, in a sensor network system, if a sensor node is present from which no response is received, another sensor node near the non-responding sensor node is requested to run diagnostics for the non-responding sensor node and based on the diagnostic result, node failures and poor wireless connections are distinguished (for example, refer to Japanese Laid-Open Patent Publication No. 2007-124148).

Nonetheless, in the sensor network system, if the amount of power that can be stored by the communication nodes is minimal, successive signal transmission cannot be performed and reciprocal signal propagation may become difficult. In this case, since responses from the communication nodes cannot be returned to the information processing apparatus that instructed the signal transmission, the determination of abnormalities related to the communication nodes is difficult.

### SUMMARY

According to an aspect of an embodiment, a determining method is executed by a computer having a storage device storing therein information. The determining method includes writing to the storage device, first information related to a first communication path that is from a first communications apparatus to a second communication apparatus when the second communications apparatus, which is different from the first communications apparatus, receives a transmission signal that is from communications nodes and in response to a transmission instruction that is transmitted by the first communications apparatus and propagated by multi-hop communication among the communications nodes; writing to the storage device, second information related to a second communication path that is from transmission of a signal by the first communications apparatus after the writing of the first information to the storage device, to reception by the second communications apparatus, of the signal propagated by multi-hop communication among the communications nodes; and determining based on a comparison result of the first information and the second information read from the storage device, correspondence of the first communication path and the second communication path.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram depicting an example of operation by an aggregating apparatus according to an embodiment;

FIG. 2 is a block diagram depicting an example of a hardware configuration of a sensor node;

FIG. 3 is a block diagram depicting an example of a hardware configuration of the aggregating apparatus;

FIG. 4 is a diagram depicting state definitions and protocols concerning sensor nodes;

FIG. 5 is a block diagram depicting a functional configuration of the sensor node;

FIG. 6 is a block diagram depicting a functional configuration of the aggregating apparatus;

FIG. 7 is a diagram depicting an example of the flow of operations when there is no erroneous value;

FIG. 8 is a diagram depicting an example of the flow of testing when there is a failure;

FIG. 9 is a diagram depicting an example of propagation of an instruction depicted in FIGS. 7 and 8; FIG. 10 is a diagram depicting an example of a case where an abnormality related to a sensor node is present;

FIG. 11 is a diagram depicting an example of propagation in a case where an abnormality related to a sensor node is present;

FIG. 12 is a diagram depicting the flow for re-obtaining data in a case of insufficient charge;

FIG. 13 is a diagram depicting an example of propagation of a re-obtain instruction in a case of insufficient charge;

FIG. 14 is a diagram depicting an example of the flow for re-obtaining data in a case of determination of an abnormality;

FIG. 15 is a diagram depicting an example of propagation of a re-obtain instruction in a case of determination of an abnormality;

FIG. 16 is a diagram depicting a first example of the flow for testing after communication paths have been determined to not correspond;

FIG. 17 is a diagram depicting an example in which a test instruction is propagated;

FIG. 18 is a diagram depicting a second example of the flow of testing after an abnormality has been determined;

FIG. 19 is a diagram depicting an example in which test results at the time of failure are propagated;

FIG. 20 is a diagram depicting an example in which a test instruction is propagated in a case where there is an abnormality in a positional relation;

FIG. 21 is a diagram depicting an example in which there is no response for barrier synchronization;

FIG. 22 is a flowchart depicting a first example of a procedure of a determining process by the aggregating apparatus;

FIG. 23 is a flowchart depicting a second example of a procedure of the determining process by the aggregating apparatus;

FIG. 24 is a flowchart depicting a third example of a procedure of the determining process by the aggregating apparatus;

FIG. 25 is a flowchart depicting a fourth example of a procedure of the determining process by the aggregating apparatus; and

FIG. 26 is a flowchart depicting an example of a procedure of the barrier synchronization process by the aggregating apparatuses.

### DESCRIPTION OF EMBODIMENTS

Embodiments of determining method and a system will be described in detail with reference to the accompanying drawings.

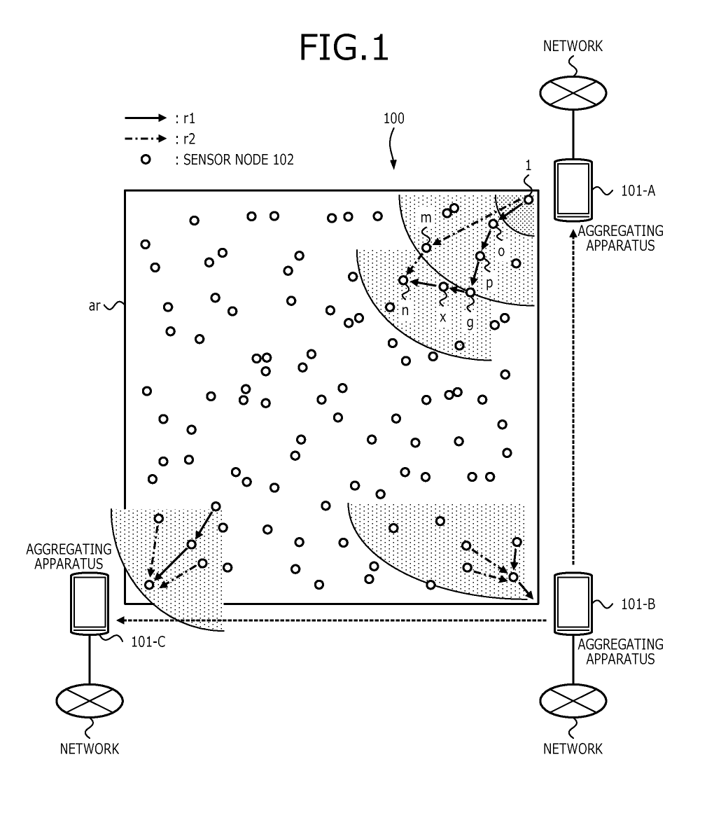

FIG. 1 is a diagram depicting an example of operation by an aggregating apparatus according to an embodiment. A system 100 includes aggregating apparatuses 101 that are communications apparatuses, and sensor nodes 102 that are communications nodes. Each aggregating apparatus 101 is a computer that transmits transmission instructions, receives transmission signals for the transmission instructions, and executes processing corresponding to the transmission signals. In the system 100, the sensor nodes 102, which are interspersed in an installation area_ar subject to measurement, operate cooperatively through multi-hop communication.

Each sensor node 102 has a sensor, a harvester that spontaneously generates power, and a battery that stores the generated power. Compared to a mobile terminal apparatus such as a personal computer (PC) or a mobile telephone, each sensor node 102 has a low amount of available power and low performance such as that of a microprocessor (hereinafter, “micro control unit (MCU)”.

Since the battery is charged by the harvester, the amount of power that the sensor nodes 102 can store is low. Thus, when the sensor nodes 102 perform one session of a series of operations such as sensing, executing a process according to the sensing, and transmitting execution results, the power of the battery drops and no operations can be performed for a given period while the battery is being charged. The sensor nodes 102 cannot reciprocate the signal propagation by returning the signal propagation to the transmission source of the transmission instruction.

Thus, in the system 100 according to the present embodiment, a transmission instruction transmitted by a given aggregating apparatus 101 is propagated through multi-hop communication by the sensor nodes 102. Furthermore, in the system 100, transmission signals from the sensor nodes 102 in response to the transmission instruction are received by aggregating apparatuses 101 different from the given aggregating apparatus, through multi-hop communication. The aggregating apparatuses 101 receiving the transmission signal execute a process based on the transmission signal. The aggregating apparatuses 101 are assumed to be able to communicate through a network NET. Even if signal propagation for a transmission instruction cannot be reciprocated to the transmission source of the transmission instruction one time, other aggregating apparatuses 101 receive transmission signals from the sensor nodes 102.

Here, characteristics of the sensor nodes 102 are given. The sensor nodes 102 are arbitrarily interspersed in the installation area_ar and therefore, for any given sensor node 102, it is not clear which sensor nodes 102 are nearby nor is the position of the sensor node 102 in the installation area_ar clear. Although the sensor nodes 102 have multiple states such as self-diagnostics and data processing, the sensor nodes 102 cannot perform multiple interrupt processing, or there is a constraint on multiple interrupt processing. For example, a sensor node 102 cannot autonomously transmit to the aggregating apparatuses 101, information indicating that the sensor node 102 has a problem. Further, for example, since the sensor node 102 cannot perform multiple interrupt processing, when a failure occurs, the sensor node 102 may not respond or may transmit corrupt data.

Further, if the sensor nodes 102 do not have the same quality, failure among the sensor nodes 102 will occur with an arbitrary probability.

As described, aggregating apparatuses 101 different from the aggregating apparatus 101 that transmitted the transmission instruction receive transmission signals for the transmission instruction. The transmission instruction, for example, is an instruction (obtain_data instruction) for the sensor nodes 102 to transmit sensing data concerning sensing.

Here, an example will be described in which an aggregating apparatus 101-A is assumed to be a first communications apparatus that transmits a transmission instruction, and an aggregating apparatus 101-B is assumed to be a second communications apparatus that receives transmission signals for the transmission instruction. The aggregating apparatus 101-B receives by multi-hop communication among the sensor nodes 102, transmission signals that are from the sensor nodes 102 and for the transmission instruction propagated by multi-hop communication among the sensor nodes 102. A computer obtains first information that is related to a first communication path r1 that is from the aggregating apparatus 101-A to the aggregating apparatus 101-B when the aggregating apparatus 101-B receives the transmission signal. Here, the computer may be an aggregating apparatus 101 or another apparatus connected to the network NET. For example, if the computer is a computer provided in the aggregating apparatus 101-B, the burden of causing another communications apparatus to transfer the first information can be omitted. The first information related to the first communication path r1, for example, may be a string of identification information of the sensor nodes 102 through which the path passed, arranged in the sequence passed; or may be the hop count of the first communication path r1.

The computer obtains from a storage apparatus, second information related to a second communication path r2 that is from transmission of a signal by the aggregating apparatus 101-A to reception of the signal by the aggregating apparatus 101-B through propagation by multi-hop communication among the sensor nodes 102. The second information related to the second communication path r2, for example, is the same type of data as the first information related to the first communication path r1. The storage apparatus, for example, may be read-only memory (ROM), random access memory (RAM), non-volatile memory, etc. The computer compares the first information and the second information to thereby, determine correspondence of the first communication path r1 and the second communication path r2.

Thus, even if no transmission signal returns to the aggregating apparatus 101 that is the transmission source of a transmission instruction, an abnormality related to a sensor node 102 among the sensor nodes 102 can be determined.

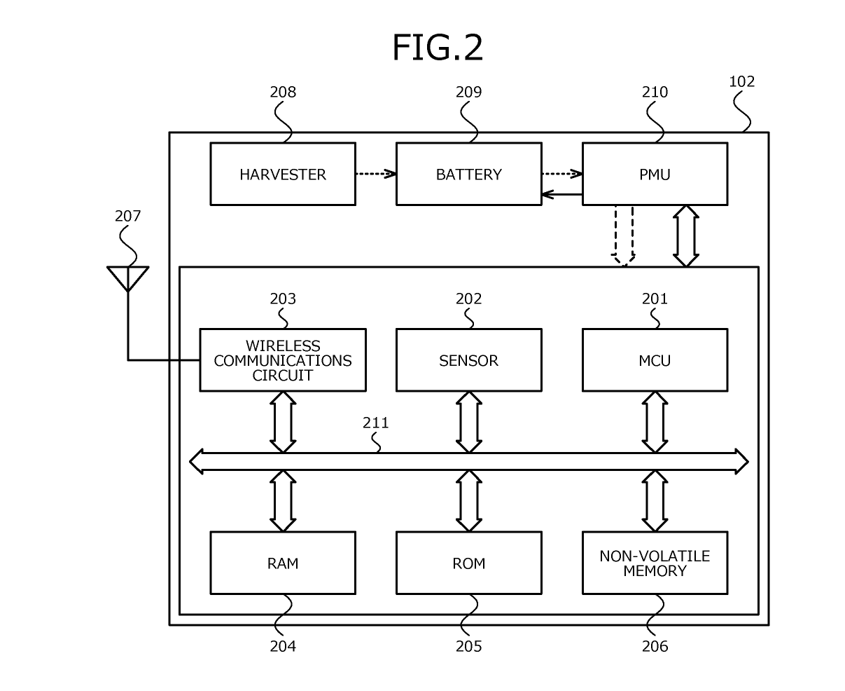

FIG. 2 is a block diagram depicting an example of a hardware configuration of a sensor node. Each sensor node 102 includes a MCU 201, a sensor 202, a wireless communications circuit (radio frequency (RF)) 203, RAM 204, ROM 205, non-volatile memory 206, an antenna 207, a harvester 208, a battery 209, and a power management unit (PMU 210). The sensor node 102 further has an internal bus 211 connecting the MCU 201, the sensor 202, the wireless communications circuit 203, the RAM 204, the ROM 205, and the non-volatile memory 206.

The sensor 202 detects a given displacement at the installation site. For example, a piezoelectric element that detects voltage at the installation site, an element that detects temperature, a photoelectric element that detects light, and the like can be used as the sensor 304. The antenna 207 transmits and receives radio waves wirelessly communicated with the aggregating apparatuses 101. The wireless communications circuit 203 outputs received wireless radio waves as a reception signal and transmits transmission signals as wireless radio signals via the antenna 207.

The MCU 201 processes data related to sensing by the sensor 202. The RAM 204 stores transient data of the processing by the MCU 201. The ROM 205 stores process programs executed by the MCU 201. The non-volatile memory 206 is writable memory that retains data written thereto even when the power supply ceases. For example, the non-volatile memory 206, which is writable, may be flash memory.

The harvester 208 generates power based on the external environment of the installation site of the sensor node 102, for example, energy changes such as changes in light, vibration, temperature, radio waves (received radio waves) and the like. The harvester 208 may generate power in response to displacement detected by the sensor 202. The battery 209 stores the power generated by the harvester 208. In other words, the sensor node 102 internally generates the power necessary for operation without the need of a secondary battery or external power source. The PMU 210 controls, as a driving source of the components of the sensor node 102, the supply of the power stored by the battery 209.

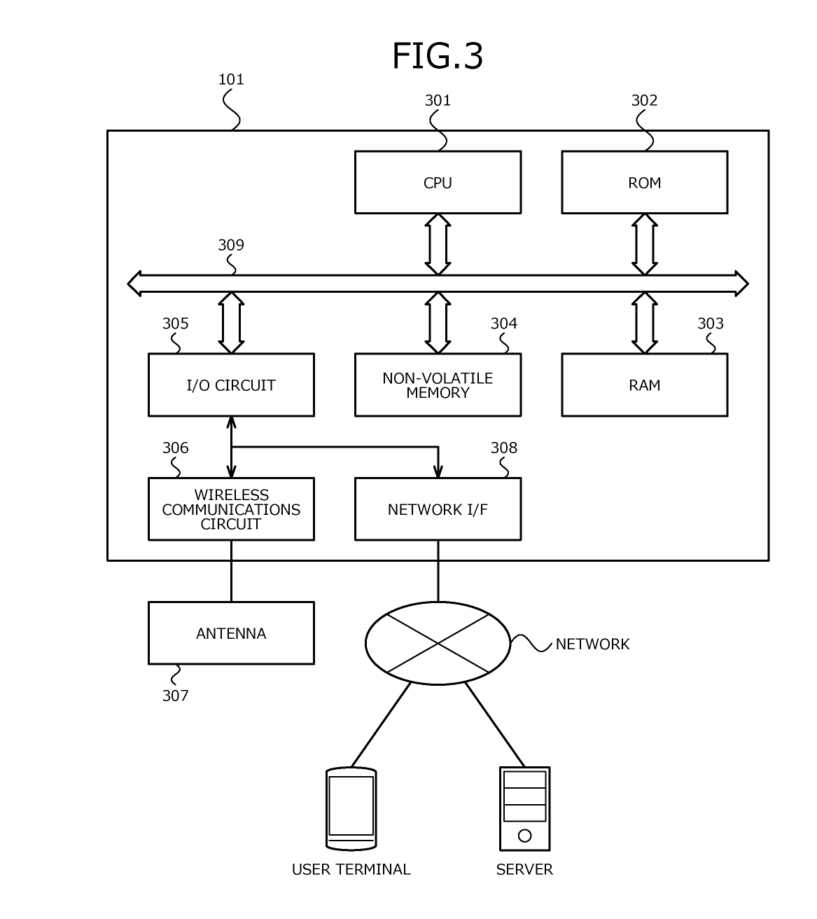

FIG. 3 is a block diagram depicting an example of a hardware configuration of an aggregating apparatus. Each aggregating apparatus 101 operates by an external power source, unlike the sensor nodes 102. The aggregating apparatus 101 includes a processor (central processing unit (CPU)) 301 that is more sophisticated than the MCU 201 of the sensor nodes 102, large-capacity ROM 302, RAM 303 and non-volatile memory 304, and an interface (input/output (I/O)) circuit 305. The aggregating apparatus 101 further has a bus 309 connecting the CPU 301, the ROM 302, the RAM 303, the non-volatile memory 304, and the I/O circuit 305.

The CPU 301 governs overall control of the aggregating apparatus 101. The CPU 301 executes various types of programs such as a determining program stored in a storage apparatus such as the ROM 302, the RAM 303, and the non-volatile memory 304, reads out data in the storage apparatus, and writes data of execution results to the storage apparatus.

The I/O circuit 305 is further connected to an antenna 307 and a wireless communications circuit (RF) 306, and a network I/F 308. As a result, the aggregating apparatus 101 can wirelessly communicate with the sensor nodes 102 through the antenna 307 and the wireless communications circuit 306. Through the network I/F 308, the aggregating apparatus 101 can communicate with external apparatuses, such as a server or a user terminal, through the network NET (e.g., the Internet) by a TCP/IP protocol process. Although not depicted, the aggregating apparatus 101 may further have an input apparatus and/or output apparatus such as a display, keyboard, or a touch panel display.

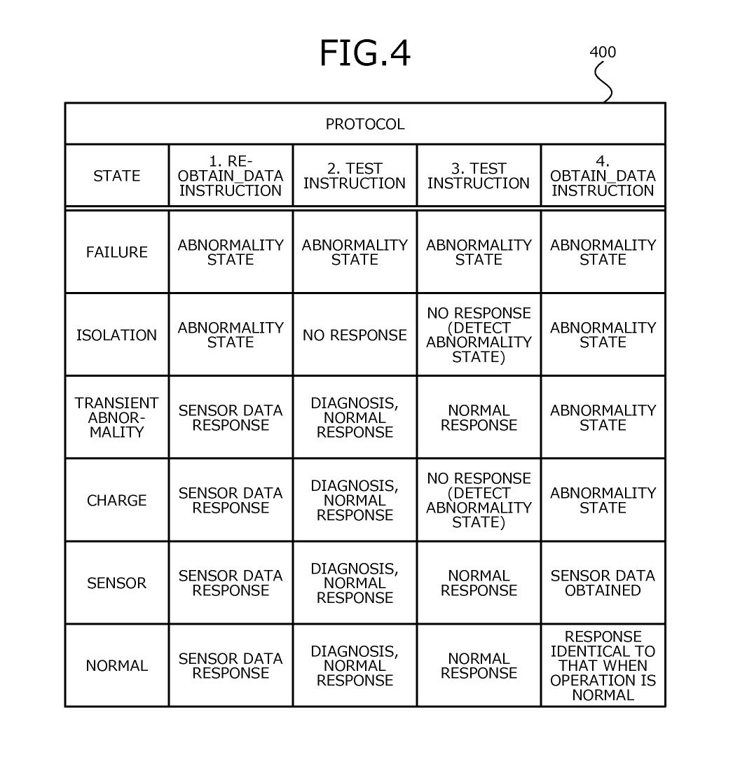

FIG. 4 is a diagram depicting state definitions and protocols concerning the sensor nodes. Table 400 depicts states of the sensor node 102 according to protocol. For example, in the present embodiment, four protocols are defined by the aggregating apparatus 101. Protocol 1 is a re-obtain_data instruction; protocol 2 is a test instruction; protocol 3 is a test instruction; and protocol 4 is an obtain_data instruction. The test instruction is an instruction for the sensor nodes 102 to perform a self-test. The re-obtain_data instruction is an instruction for re-obtaining data to identify the type of abnormality, when an abnormality is determined in relation to a sensor node 102. Protocol 2 is transmitted to identify the type of abnormality, when an abnormality is determined in relation to the sensor nodes 102. On the other hand, protocol 3 is transmitted to cause the sensor nodes 102 to perform a self-test periodically.

In this example, states of the sensor node 102 include failure, isolation, transient abnormality, charge, sensor, and normal. The failure state indicates failure of the hardware of the sensor node 102. The isolation state indicates that the sensor node 102 cannot perform multi-hop communication with other sensor nodes 102. For example, the isolation state occurs consequent to non-arrival resulting from an environmental fracture at the installation site of the sensor node 102 or changes in the state of the installation site of the sensor node 102. More specifically, in a case where the sensor nodes 102 are embedded in a wall, an environmental fracture is indicative of the positional relations changing between a given sensor node 102 and other sensor nodes 102 consequent to the position of the given sensor node 102 deviating if the wall collapses.

The transient abnormal state represents a state in which an incidental abnormality occurs consequent to, for example, noise while the sensor node 102 is responding. The charge state, for example, indicates that the battery 209 is being charged. As described, the amount of power stored by the battery 209 of the sensor node 102 is minimal. Here, for example, the sensor node 102 is assumed to exhaust the power stored in the battery 209 by merely performing a series of operations such as receiving an instruction and executing a process for the instruction. Nonetheless, the configuration of the sensor node 102 is not particularly limited and various modifications are possible.

The sensor state, for example, represents a state in which sensing is being autonomously performed by the sensor node 102. As described, since the sensor node 102 cannot perform multiple interrupt processing, no instructions can be received during sensing. The normal state, for example, represents a state in which no abnormalities occur in relation to the sensor node 102.

In table 400, protocol 1 and protocol 2 are protocols performed after an abnormality has been determined in relation to the sensor node 102. Therefore, before transmitting protocol 1 or protocol 2, the aggregating apparatus 101 stands by for a charging period, which is the time consumed to charge the sensor node 102. Thus, at the time of transmission of protocol 1 and protocol 2, if the abnormal state is the charge state, a response identical to that when operation is normal is received from the sensor node 102.

In the case of the transient abnormality state or the sensor state, by re-performing communication, the possibility of the abnormality being resolved is high. Therefore, in table 400, at the time of transmission of protocol 1 or protocol 2, a response identical to that when operation is normal is assumed to be received from the sensor node 102. Further, in the case of the isolation state, since neither protocol 2 nor protocol 1 can be received, there is no response.

If the sensor node 102 fails, there may be silence without a response or there may be a response but an erroneous value may be output in response to an obtain_data instruction such as protocol 4 and protocol 1. On the other hand, concerning a test instruction such as protocol 2 and protocol 3, the sensor node 102 responds that the sensor node 102 is abnormal. However, if the wireless communications circuit 203 and/or the antenna 207 have failed, the sensor node 102 cannot transmit or receive and therefore, does not respond. In this case, the failure is a failure consequent to abnormal operation of the sensor, a bug in software processing, memory damage, etc., although the hardware operates normally and the software also is operated normally by the program counter. Furthermore, the failure in this case is indicative of a case where although the sensor node 102 responds with a diagnostic measurement, which is the self-testing function of the sensor node 102, the response does not return a normal value.

Further, although not depicted, as a protocol between the aggregating apparatuses 101, there is a barrier synchronization process between the aggregating apparatuses 101. In the present embodiment, a synchronized state is established by barrier synchronization, after the aggregating apparatuses 101 finish processes under execution; and after all of the aggregating apparatuses 101 have entered a synchronized state, a process related to the next protocol is executed.

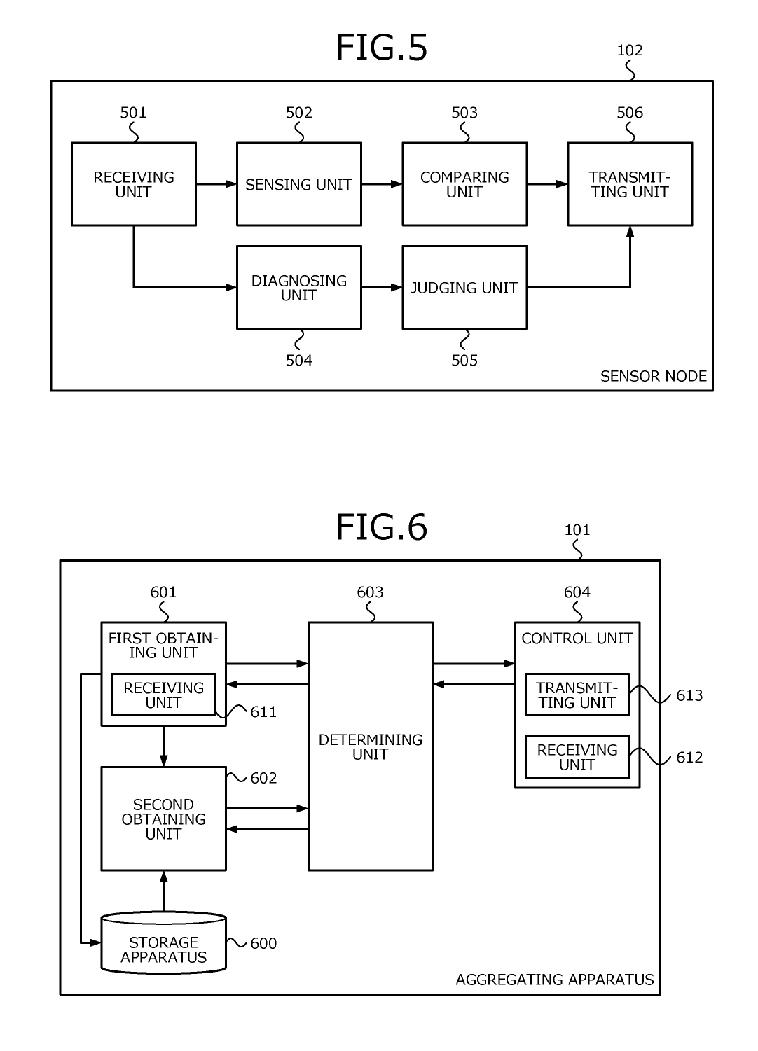

FIG. 5 is a block diagram depicting a functional configuration of the sensor node. The sensor node 102 includes a receiving unit 501, a sensing unit 502, a comparing unit 503, a diagnosing unit 504, a judging unit 505, and a transmitting unit 506. The sensing unit 502 is the sensor 202; the receiving unit 501 and the transmitting unit 506 are realized by the wireless communications circuit 203 and the antenna 207. More specifically, for example, the MCU 201 reads out the determining program that is stored in a storage apparatus such as the RAM 204, the ROM 205, and the non-volatile memory 206 depicted in FIG. 2 and in which functions of the units depicted in FIG. 5 are encoded, and executes the processes encoded in the determining program, whereby the functions of the units are realized.

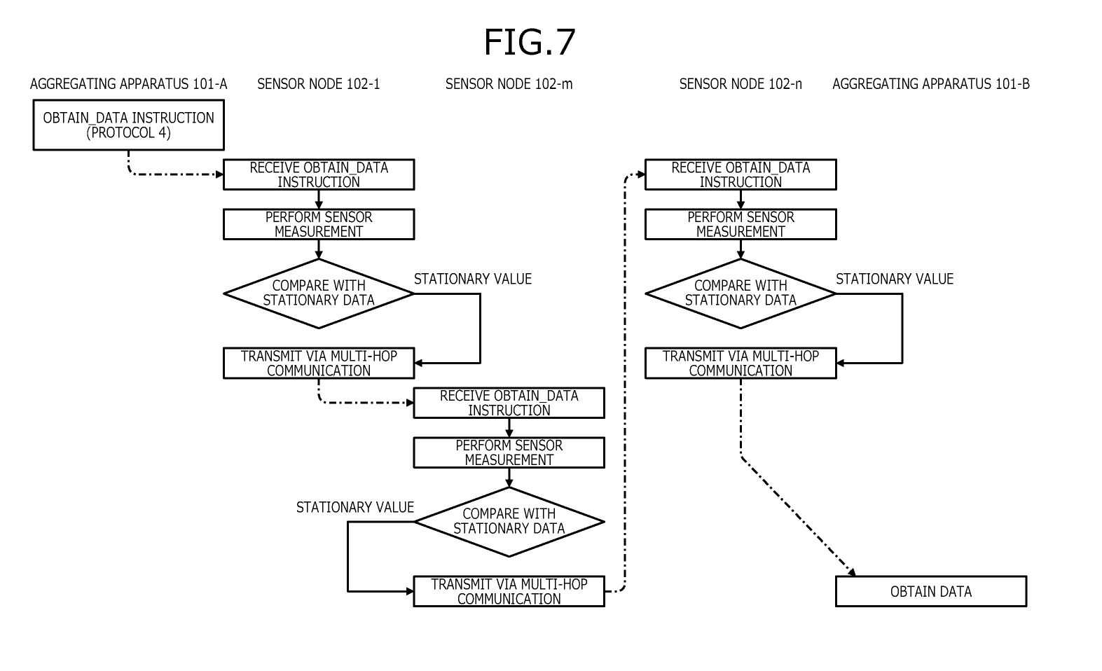

FIG. 6 is a block diagram depicting a functional configuration of the aggregating apparatus. The aggregating apparatus 101 includes a storage apparatus 600, a first obtaining unit 601, a second obtaining unit 602, a determining unit 603, and a control unit 604. The first obtaining unit 601 includes a receiving unit 611; and the control unit 604 includes a receiving unit 612 and a transmitting unit 613.

The receiving unit 611, the receiving unit 612, and the transmitting unit 613, for example, are realized by the wireless communications circuit 306, the antenna 307, and the network I/F 308. More specifically, for example, the CPU 301 reads out the determining program that is stored in a storage apparatus such as the ROM 302, the RAM 303, and the non-volatile memory 304 depicted in FIG. 3 and in which functions of the units depicted in FIG. 6 are encoded, and executes the processes encoded in the determining program, whereby the functions of the units are realized. Further, the determining program may be obtained through the network I/F 308.

The storage apparatus 600 is realized by the ROM 302, the RAM 303, the non-volatile memory 304, etc. The storage apparatus 600 stores therein information related to stationary communication paths between the aggregating apparatuses 101. Each of the installed aggregating apparatuses 101 has the potential of being a protocol sending source. Information related to stationary communication paths has to be stored to the storage apparatus 600, including all patterns of sending from the aggregating apparatuses 101. Therefore, the information related to the stationary communication paths is preliminarily stored to the storage apparatus 600 for the number of cases in which a given aggregating apparatus 101 is not the protocol sending source, i.e., for “a count of the aggregating apparatuses 101 less 1”.

Detailed description of the functional units of the aggregating apparatus 101 and the sensor node 102 will be given in the context of the protocols described above.

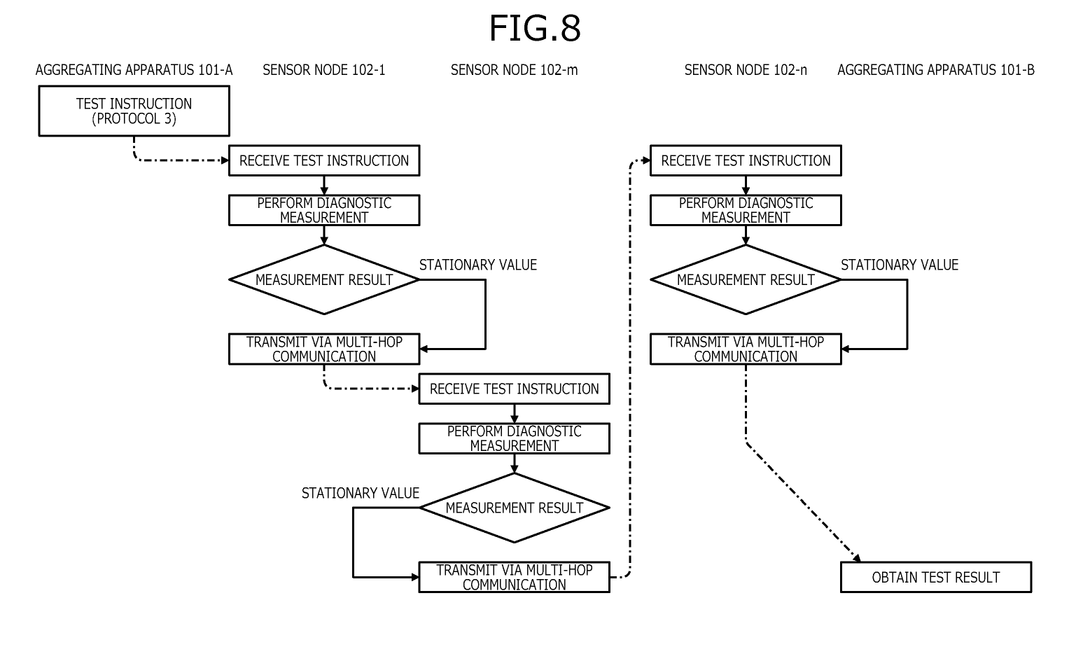

FIG. 7 is a diagram depicting an example of the flow of operations when there is no erroneous value. In the example depicted in FIG. 7, an example of communication by protocol 4 is depicted. Here, an example is depicted in which the aggregating apparatus 101-A has transmitted by protocol 4, an obtain_data instruction, which is a transmission instruction. The sensor nodes 102 perform multi-hop communication of obtain_data instruction and thereby, obtain data according to the obtain_data instruction and propagate the obtain_data instruction to the aggregating apparatus 101-B and/or an aggregating apparatus 101-C.

More specifically, in the sensor nodes 102, when the receiving unit 501 receives the obtain_data instruction, the sensing unit 502 performs measurement by the sensor. Here, the receiving unit 501 obtains the obtain_data instruction together with judgment results of other sensor nodes 102.

Further, in the sensor nodes 102, the comparing unit 503 compares the sensing data obtained by the sensing unit 502 and stationary data, and thereby judges whether the sensing data is an erroneous value. A case where the sensing data is not an erroneous value is called a stationary value. In the sensor nodes 102, the transmitting unit 506 transmits to a sensor node 102 with which direct communication is possible, the received judgment results of the other sensor nodes 102, the judgment result thereof, the information related to the communication paths, and the obtain_data instruction. In the example depicted in FIG. 7, the obtain_data instruction and the data obtained according to the obtain_data instruction are propagated in the sequence of a sensor node 102-1, a sensor node 102-m, and a sensor node 102-n. For example, the sensor nodes 102 arrange the obtained data in the propagation sequence and transmit the identification information of the sensor node 102 therewith and thereby, transmit information related to the communication path from the aggregating apparatus 101 that is the transmission source of the obtain_data instruction. The obtained data is a transmission signal from each sensor node 102, for the obtain_data instruction.

Here, an example will be described where the obtain_data instruction transmitted by the aggregating apparatus 101-A is propagated by multi-hop communication among the sensor nodes 102; and the data obtained by the sensor nodes 102, for the propagated obtain_data instruction is received by the aggregating apparatus 101-B by multi-hop communication among the sensor nodes 102. For ease of understanding, in FIG. 7, the number of sensor nodes 102 is reduced, however, in actuality, the sensor nodes 102 are of a great number. Furthermore, the computer that executes processes related to the determining method is assumed to be provided in plural and the aggregating apparatuses 101 are assumed to operate cooperatively.

More specifically, the first obtaining unit 601-B obtains the first information related to the first communication path r1 that is from the aggregating apparatus 101-A to the aggregating apparatus 101-B when the aggregating apparatus 101-B receives the data obtained by the sensor nodes 102 by multi-hop communication. The first obtaining unit 601-B writes the obtained first information to a storage apparatus such as RAM 303-B. The first information related to the first communication path r1, for example, may be a string of identification information of the sensor nodes 102 through which the path passed, arranged in the order passed; or may be the hop count of the first communication path r1. For example, the first obtaining unit 601-B receives the data obtained by plural sensor nodes 102 together with a string of identification information of the sensor nodes 102 through which the path passed, arranged in the order passed.

The second obtaining unit 602-B obtains the second information related to the second communication path r2 and stored in the storage apparatus 600. The second obtaining unit 602-B writes the obtained second information to a storage apparatus such as the RAM 303-B. Here, the second communication path r2 is from transmission of a signal by the aggregating apparatus 101-A to reception of the signal propagated by multi-hop communication among the sensor nodes 102 by the aggregating apparatus 101-B. The second information related to the second communication path r2, similar to the first information related to the first communication path r1, for example, may be a string of identification information of the sensor nodes 102 through which the path passed, arranged in the order passed; or may be the hop count of the second communication path r2. The first information and the second information are of the same type. More specifically, the second obtaining unit 602-B reads out from the storage apparatus 600, the second information related to the second communication path r2. Further, there may be plural candidates for the communication path and therefore, information related to the second communication path r2 may be of plural types. Further, plural communication paths are possible for a single obtain_data instruction session and therefore, there are plural first communication paths r1 and second communication paths r2.

The determining unit 603-B compares the first information obtained by the first obtaining unit 601-B and the second information obtained by the second obtaining unit 602-B. More specifically, the determining unit 603-B compares the first information and the second information read out from a storage apparatus such as the RAM 303-B. As a result, the determining unit 603-B determines whether among the sensor nodes 102, an abnormality is present related to a sensor node 102. For example, when the first information and the second information correspond, the determining unit 603-B judges that the first communication path r1 and the second communication path r2 correspond. If the communication path is the same as a stationary communication path, the sensor node 102 responds and even if the positional relation between sensor nodes 102 has changed, if communication with another sensor node 102 is possible to respond, it can be determined that no abnormality related to the sensor node 102 is present.

On the other hand, for example, if the first information and the second information do not correspond, the determining unit 603-B judges that the first communication path r1 and the second communication path r2 do not correspond. If the communication path is not the same as a stationary communication, the sensor node 102 may not respond or may be unable to respond consequent to a change in the positional relation between the sensor nodes 102 and therefore, it can be determined that an abnormality related to a sensor node 102 is present.

For example, if the first information and the second information are hop counts, the determining unit 603-B may determine that the first communication path r1 and the second communication path r2 do not correspond if the difference of the first information and the second information within a given range. It can be determined that no abnormality related to a sensor node 102 is present. On the other hand, for example, if the first information and the second information are hop counts, the determining unit 603-B may judge that the first communication path r1 and the second communication path r2 correspond if the difference of the first information and the second information is not within the given range. It can be determined that an abnormality related to a sensor node 102 is present. The given range may be defined by the designer of the system 100 according to the communication paths at the time of design of the system 100 or the number of sensor nodes 102, or may be defined by the user. FIG. 7 depicts an example in which it is determined that no abnormality related to a sensor node 102 is present.

The determining unit 603-B may further determine whether among the obtained data received from plural sensor nodes 102, information indicative of an erroneous value is included.

Further, the aggregating apparatus 101-B, which has received the data obtained consequent to protocol 4, may transfer the data to another aggregating apparatus 101 or to another computer with which communication is possible. As a result, the aggregating apparatus 101-B may cause another aggregating apparatus 101 or another computer with which communication is possible to execute processes related to abnormality determination by the functional units. Further, the aggregating apparatus 101-B, which has received the data, can omit the process of transferring the data by executing processes related to abnormality determination.

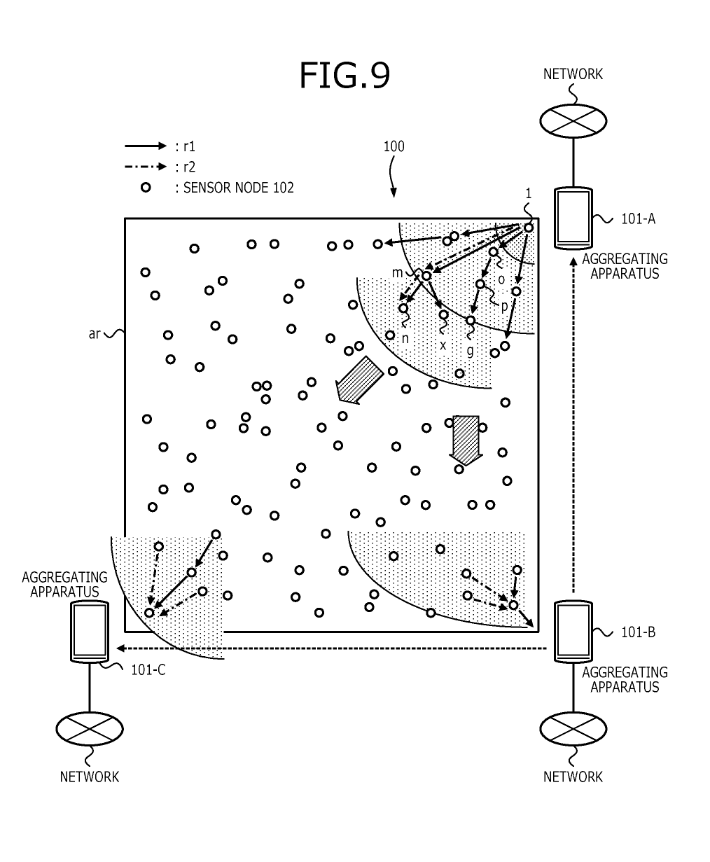

FIG. 8 is a diagram depicting an example of the flow of testing when there is a failure. The example depicted in FIG. 8 depicts an example of communication by protocol 3. For example, the aggregating apparatus 101-A transmits a test instruction. By propagating the test instruction by multi-hop communication, the sensor nodes 102 execute self-tests according to the test instruction while propagating the test results to the aggregating apparatus 101-B and the aggregating apparatus 101-C.

More specifically, in the sensor nodes 102, when the receiving unit 501 receives the test instruction, the diagnosing unit 504 performs diagnostic measurement, whereby self-diagnosis is performed. Here, together with the test instruction, the receiving unit 501 obtains test results of other sensor nodes 102, multi-hopped from the aggregating apparatus 101-A. For example, the multi-hopped test results of other sensor nodes 102 are appended with the identification of the sensor node 102 passed and are arranged in the sequence passed.

In the sensor nodes 102, the judging unit 505 judges whether the diagnostic measurement result obtained by the diagnosing unit 504 is an erroneous value indicating failure. A case where the measurement result is not an erroneous value indicating failure is called a stationary value. In the example depicted in FIG. 8, the measurement results of the sensor nodes 102 are all stationary values. The transmitting unit 506 transmits to nearby sensor nodes 102, via multi-hop communication, the test result obtained by the judging unit 505 and to which the identification information of the sensor node 102 thereof is appended. Together with the test result, the transmitting unit 506 further transmits the test instruction received by the receiving unit 501 and the multi-hopped test results of other sensor nodes 102 to the nearby sensor nodes 102, via multi-hop communication.

In the example depicted in FIG. 8, the test instruction and the test results for the test instruction are propagated in the sequence of the sensor node 102-1, the sensor node 102-m, and the sensor node 102-n. For example, the sensor nodes 102 arrange the test results in the propagation sequence and transmit the identification information of the sensor nodes 102 and thereby, transmit information related to the communication path from the aggregating apparatus 101 that is the transmission source of the test instruction.

The first obtaining unit 601-B obtains the test results of the sensor nodes 102. Here, the obtained test results are the test results for a test instruction transmitted by the aggregating apparatus 101-A, propagated by multi-hop communication among the sensor nodes 102, and received by the aggregating apparatus 101-B, which is different from the aggregating apparatus 101-A.

The determining unit 603-B determines based on the test result obtained by the first obtaining unit 601-B, whether a failure has occurred at a sensor node 102. Thus, a sensor node 102 at which a failure has occurred can be identified. For example, the determining unit 603-B determines that a sensor node 102 for which information indicates that the test result is not a stationary value has failed. On the other hand, for example, the determining unit 603-B determines that a sensor node 102 for which information indicates that the test result is a stationary value has failed.

Further, after the aggregating apparatus 101-A has transmitted the test instruction, the first obtaining unit 601-B obtains information related to the first communication path r1 that is up to the reception of the test results by the aggregating apparatus 101-B, the test results being multi-hopped among the sensor nodes 102.

The second obtaining unit 602-B obtains from the storage apparatus 600, information related to the second communication path r2. Here, the second communication path r2 is a path from transmission of a signal by the aggregating apparatus 101-A to reception of the signal by the aggregating apparatus 101-B, the signal being propagated by multi-hop communication among the sensor nodes 102.

The determining unit 603-B may compare the information obtained by the first obtaining unit 601-B and the information obtained by the second obtaining unit 602-B. For example, if the information obtained by the first obtaining unit 601-B and the information obtained by the second obtaining unit 602-B correspond, the determining unit 603-B determines that the first communication path r1 and the second communication path r2 correspond. Thus, in the case of correspondence, it can be determined that no abnormality related to the sensor nodes 102 is present. On the other hand, for example, if the information obtained by the first obtaining unit 601-B and the information obtained by the second obtaining unit 602-B do not correspond, the determining unit 603-B determines that the first communication path r1 and the second communication path r2 do not correspond. Thus, in a case of non-correspondence, it can be determined that an abnormality related to a sensor node 102 is present.

For example, irrespective of the determining unit 603-B determining no failure, if the determining unit 603-B determines that the communication paths differ, the aggregating apparatus 101-B determines that abnormality related to a sensor node 102 is present. Here, an abnormality may be a case where with respect to a sensor node 102, an abnormality has occurred concerning the positional relation with a nearby sensor node 102, or diagnosis has not be performed consequent to the charge of a sensor node 102 being insufficient. When an abnormality occurs concerning the positional relation with a nearby sensor node 102, for example, it is possible that a change in the installation environment has occurred. For example, when there is a change in the installation environment, the test instruction cannot be received, a test instruction from a different sensor node 102 from before is received, or a test instruction is propagated to a different sensor node 102 from before. FIG. 7 depicts an example in which it is determined that no erroneous value related to a sensor node 102 is present.

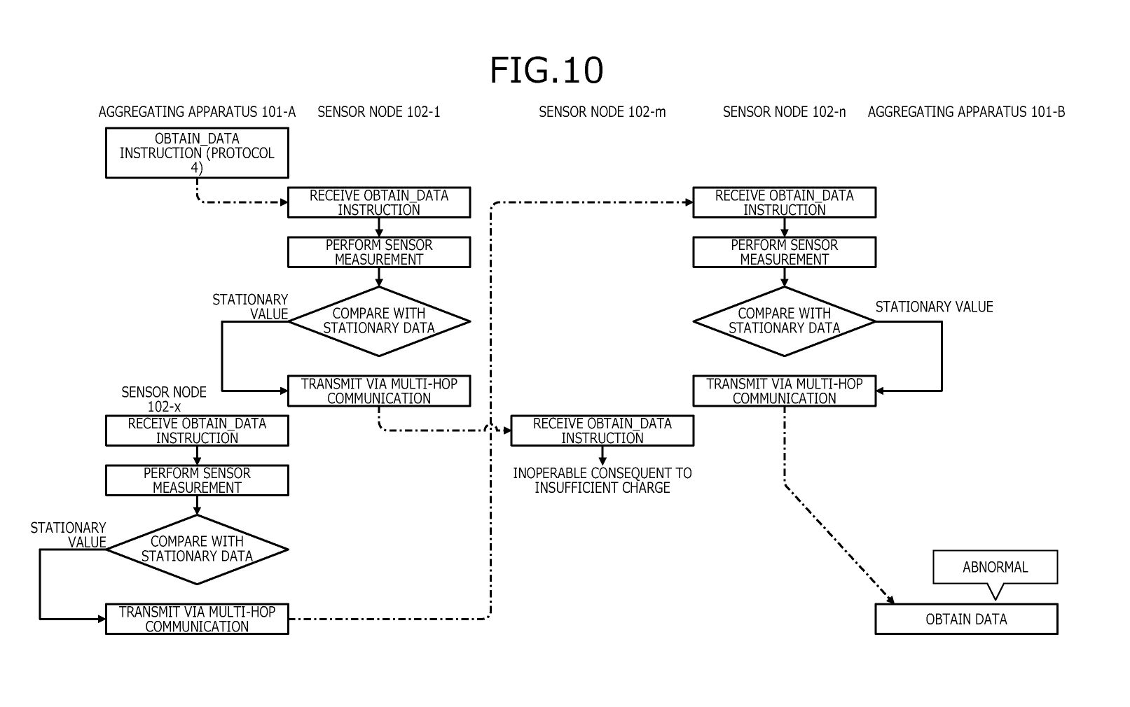

FIG. 9 is a diagram depicting an example of propagation of the instruction depicted in FIGS. 7 and 8. The aggregating apparatus 101-A transmits an obtain_data instruction or a test instruction to the sensor nodes 102. For example, the instruction and a response to the instruction are propagated in the sequence of the sensor node 102-1, the sensor node 102-m, and the sensor node 102-n, and reach the aggregating apparatus 101-B or the aggregating apparatus 101-C.

The timing at which the aggregating apparatuses 101 transmit the test instruction by protocol 3 or the obtain_data instruction by protocol 4, for example, may be at a timing specified by the user, at constant cycles, etc., and is not particularly limited.

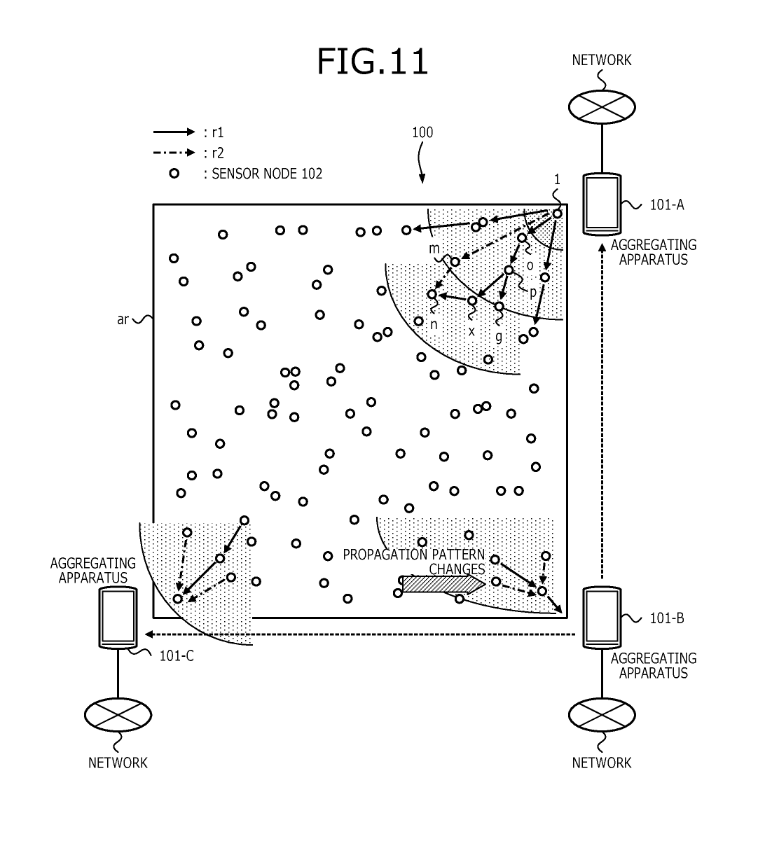

FIG. 10 is a diagram depicting an example of a case where an abnormality related to a sensor node is present. FIG. 11 is a diagram depicting an example of propagation in a case where an abnormality related to a sensor node is present. The sensor node 102-m, similar to the example depicted in FIG. 7, obtains the obtain_data instruction from the sensor node 102-1; however, the sensor node 102-m is inoperable consequent to insufficient charge. Therefore, although the sensor node 102-n receives the obtain_data instruction from the sensor node 102-m when no abnormality is present, the sensor node 102-n receives the obtain_data instruction from a sensor node 102-x. As depicted in FIG. 11, since the sensor node 102-m cannot transmit the obtain_data instruction or the data obtained for the obtain_data instruction, the propagation pattern changes.

Here, the first obtaining unit 601-B, the second obtaining unit 602-B, and the determining unit 603-B operate similar to the example described with reference to FIG. 7. Therefore, in the example depicted in FIG. 10, the determining unit 603-B determines that the first communication path r1 and the second communication path r2 do not correspond. As a result, it is determined that an abnormality related to a sensor node 102 is present.

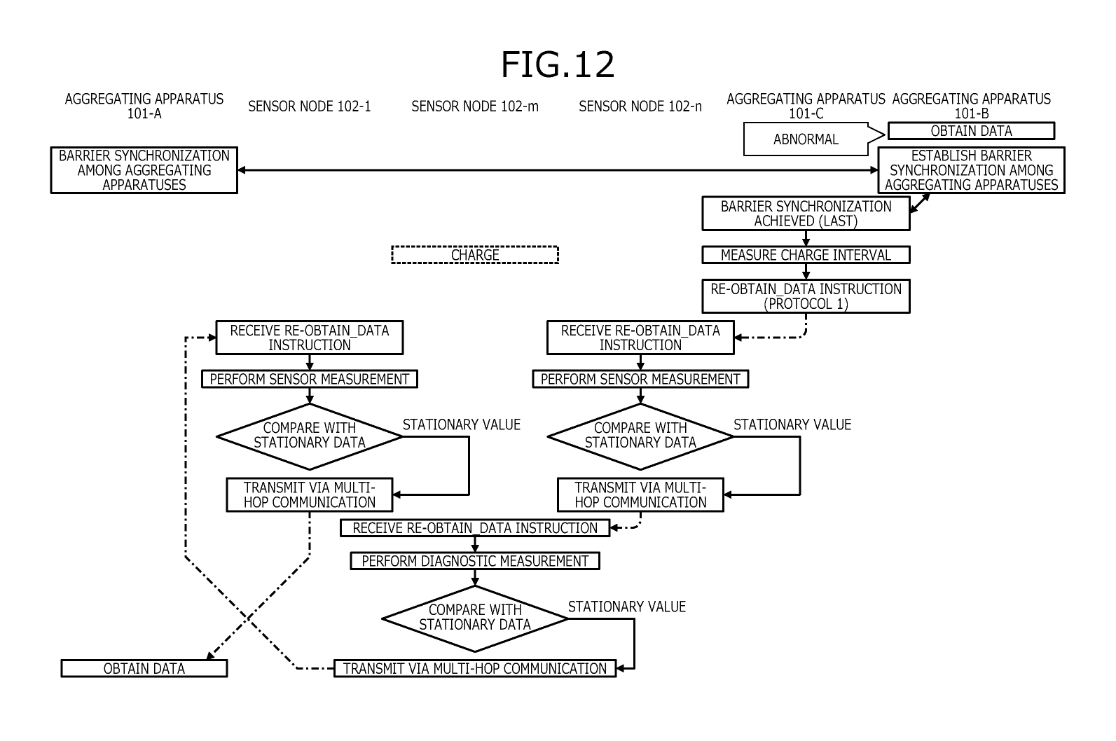

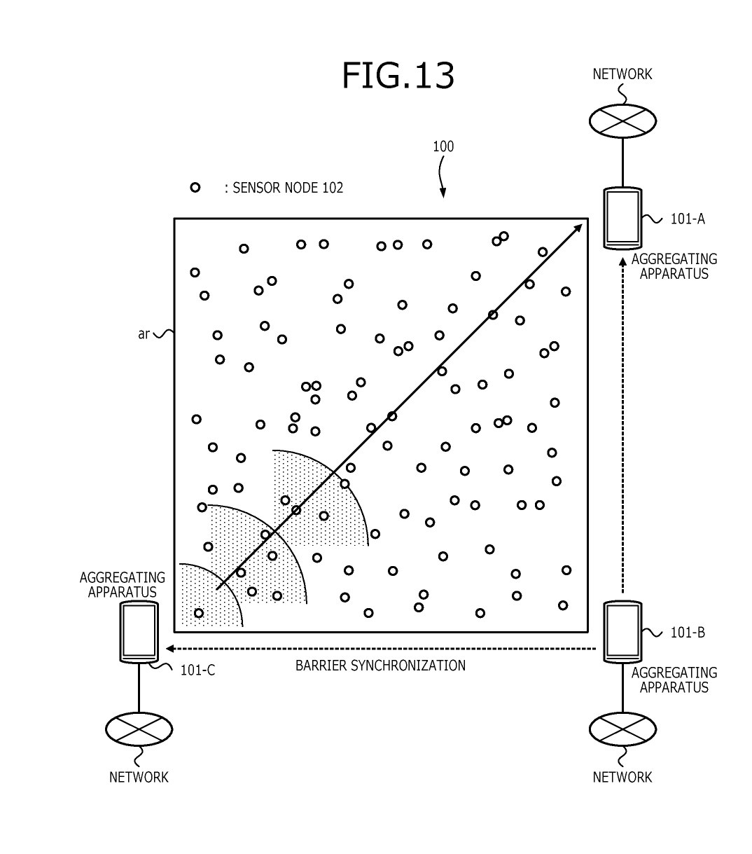

FIG. 12 is a diagram depicting the flow for re-obtaining data in a case of insufficient charge. FIG. 13 is a diagram depicting an example of propagation of a re-obtain instruction in a case of insufficient charge. FIG. 12 depicts an example of communication by protocol 1. If the determining unit 603-B determines that the first communication path r1 and the second communication path r2 do not correspond, the control unit 604-B stands by for a charging period after the aggregating apparatus 101-B has received the obtain_data signal, the charging period being the time consumed for the sensor nodes 102 to charge. The charging period is a value defined at the time of design of the sensor nodes 102. After standing by, the control unit 604-B causes a second transmission instruction to be transmitted to the sensor nodes 102 by the aggregating apparatus 101-C. Here, the second transmission instruction is the re-obtain_data instruction by protocol 1 described above.

After the determining unit 603-B has determined that the first communication path r1 and the second communication path r2 do not correspond, the control unit 604-B establishes barrier synchronization among the aggregating apparatuses 101. As a result, among the sensor nodes 102, the propagation of a test instruction related to abnormality determination can be prevented from being hindered by the propagation of another instruction. Therefore, the accuracy of the determination can be improved. The control unit 604-B causes the aggregating apparatus 101 that is last among the aggregating apparatuses 101 to enter the synchronized state by barrier synchronization to transmit the re-obtain_data instruction by protocol 1. Thus, by predetermining an aggregating apparatus among plural aggregating apparatus 101 to transmit the re-obtain_data instruction, a process of determining the aggregating apparatus that is to transmit can be omitted at the time of communication. In the example depicted in FIG. 12, since the aggregating apparatus 101-C is the last to synchronize, the aggregating apparatus 101-C transmits the re-obtain_data instruction.

The aggregating apparatus 101-C transmits the re-obtain_data instruction after standing by for the charging period after all of the aggregating apparatuses 101 have become synchronized. As a result, an aggregating apparatus transmits lastly an instruction to the sensor nodes 102 and after response to the instruction has ended, the battery 209 of each sensor node 102 can be charged. Therefore, the amount of charge of the battery 209 of each sensor node 102 becomes an amount enabling execution of each instruction. More specifically, the aggregating apparatus 101-C measures a charge interval by a timer. The aggregating apparatus 101-C transmits the re-obtain_data instruction after the charge interval has elapsed.

Here, if the sensor node 102-m cannot respond to the obtain_data instruction consequent to insufficient charge, the re-obtain_data instruction is transmitted after standby for the charging period, whereby the sensor node 102-m is able to receive the re-obtain_data instruction. In the example depicted in FIG. 12, the re-obtain_data instruction and the re-obtained results therefor are propagated in the sequence of the sensor node 102-n, the sensor node 102-m, and the sensor node 102-1. If the re-obtained results correspond with the results obtained for the obtain_data instruction by protocol 4 or are within a given range, the sensor nodes 102 need not transmit the re-obtained results. Nonetheless, the sensor nodes 102 transmit the identification information thereof to enable determination of the propagation sequence. Non-correspondence of the re-obtained results and the results obtained for the obtain_data instruction by protocol 4 is a case in which the detection state has changed consequent to a transient abnormality or a change in the installation environment such as in the temperature of the sensor node 102.

FIG. 12 depicts an example of propagation from the aggregating apparatus 101-C to the aggregating apparatus 101-A. Here, the aggregating apparatus 101-A identifies the type of abnormality related to the sensor node 102-m. The first obtaining unit 601-A obtains third information related to a third communication path from the aggregating apparatus 101-C to the aggregating apparatus 101-A. The first obtaining unit 601-A writes the obtained first information to a storage apparatus such as the RAM 303-A. Here, the third communication path is a path from transmission of the re-obtain_data instruction by the aggregating apparatus 101-C to reception of the re-obtained results by the aggregating apparatus 101-A, the re-obtained results being second transmission signals from the sensor nodes 102 in response to the re-obtain_data instruction and propagated by multi-hop communication. As described, the first obtaining unit 601-A receives third information related to the communication path.

The second obtaining unit 602-A obtains from the storage apparatus 600, fourth information related to a fourth communication path. The second obtaining unit 602-A writes the obtained fourth information to a storage apparatus such as the RAM 303-A. Here, the fourth communication path is a path from transmission of a signal by the aggregating apparatus 101-C to reception of the signal by the aggregating apparatus 101-A, the signal being multi-hopped among the sensor nodes 102.

The determining unit 603-A compares the third information obtained by the first obtaining unit 601-A and the fourth information obtained by the second obtaining unit 602-A, and thereby judges whether the third communication path and the fourth communication path correspond. More specifically, the determining unit 603-A compares the third information and the fourth information read from a storage apparatus such as the RAM 303-A. As a result, it can be determined whether an abnormality related to a sensor node 102 continues.

On the other hand, for example, if the third information obtained by the first obtaining unit 601-A and the fourth information obtained by the second obtaining unit 602-A correspond, the determining unit 603-A determines that the third communication path and the fourth communication path correspond. As a result, it can be determined whether an abnormality related to a sensor node 102 continues. Thus, an abnormality at the time when the data obtained for an obtain_data instruction is received is identified to be insufficient charge or a transient abnormality such as noise.

The determining unit 603-A may judge whether the re-obtained result from the sensor nodes 102 includes information indicative of an erroneous value.

In the example depicted in FIG. 12, the aggregating apparatus 101-A, which has received the data re-obtained for the re-obtain_data instruction by protocol 1, may transfer the re-obtained data to another aggregating apparatus 101 or another computer with which communication is possible. As a result, the aggregating apparatus 101-A may cause the other aggregating apparatus 101 or the other computer with which communication is possible to execute a process related to the abnormality determination by the functional units. Further, the aggregating apparatus 101-A, which has received the re-obtained data, may perform the process related to the abnormality determination, thereby enabling the process of transferring the re-obtained data to be omitted.

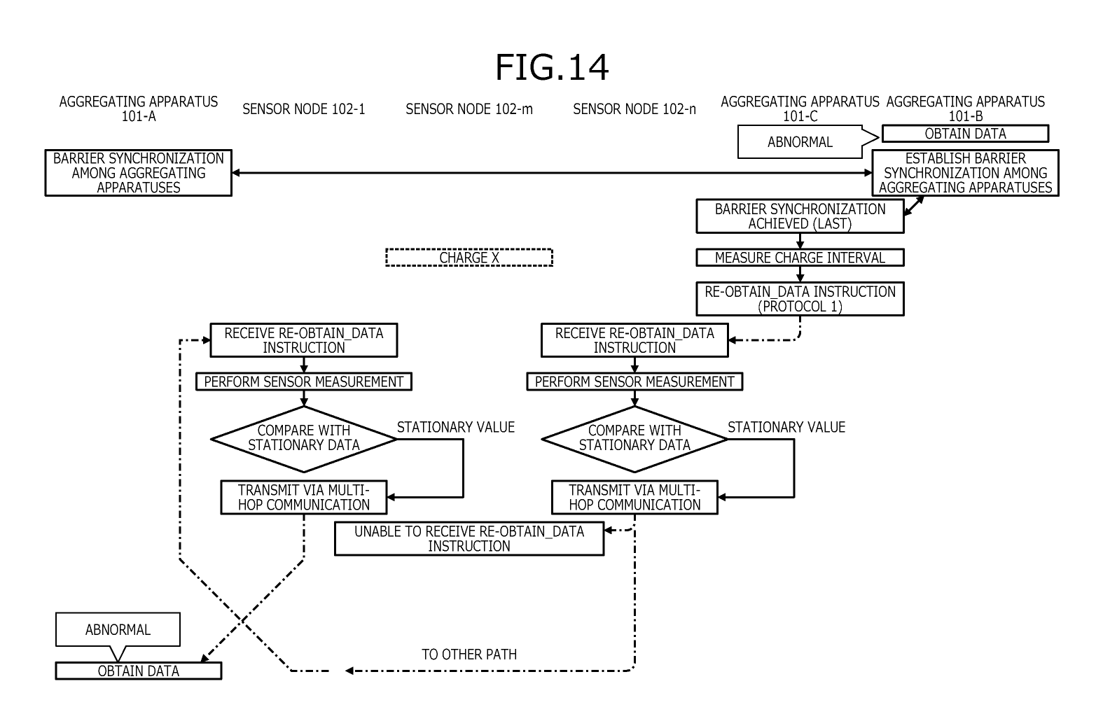

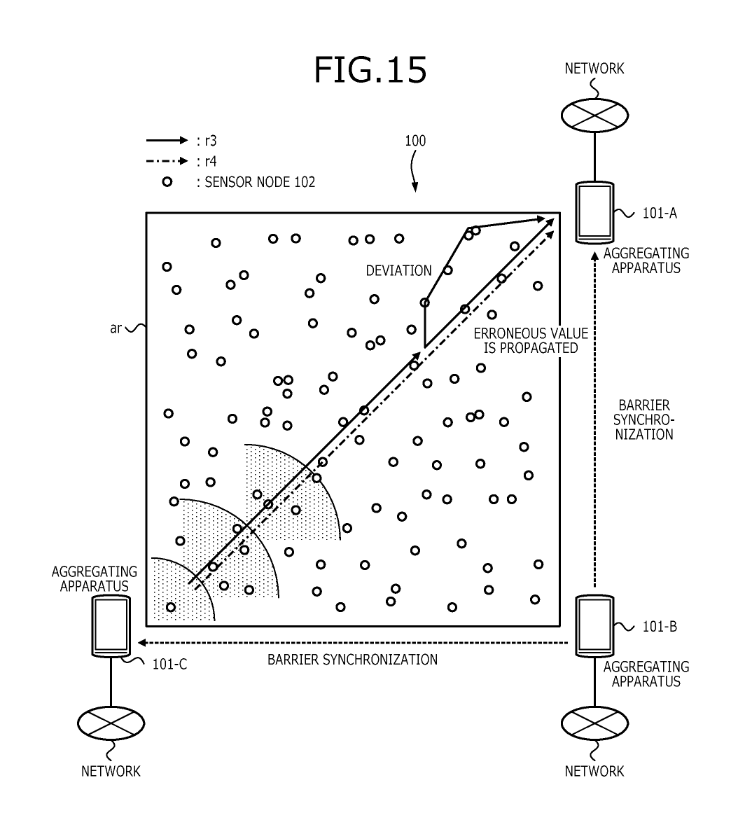

FIG. 14 is a diagram depicting an example of the flow for re-obtaining data in a case of determination of an abnormality. FIG. 15 is a diagram depicting an example of propagation of a re-obtain instruction in a case of determination of an abnormality. FIG. 14 depicts an example of communication by protocol 1. In the example depicted in FIG. 14, a re-obtain_data instruction and the re-obtained result for the re-obtain_data instruction are propagated in the sequence of the sensor node 102-n and the sensor node 102-1, and the sensor node 102-m is unable to receive the re-obtain_data instruction. A third communication path r3 may follow the same path as a fourth communication path r4 or may deviate therefrom.

For example, if the third information obtained by the first obtaining unit 601-A and the fourth information obtained by the second obtaining unit 602-A do not correspond, the determining unit 603-A determines that the third communication path r3 and the fourth communication path r4 do not correspond. As a result, it can be determined that an abnormality related to a sensor node 102 continues. Thus, it can be determined that an abnormality has occurred that is different from an abnormality that occurred transiently such as noise or insufficient charge.

Further, as depicted in FIG. 15, when an erroneous value is present in the data re-obtained for the re-obtain_data instruction, the erroneous value is propagated. Therefore, the determining unit 603-A may determine based on the re-obtained results from the sensor nodes 102, whether the re-obtained results include information indicative of an erroneous value. For example, if information indicative of an erroneous value is included in the re-obtained result from the sensor nodes 102, the determining unit 603-A judges that the abnormality continues. Alternatively, the determining unit 603-A judges that an abnormality has occurred that is not an abnormality that occurs transiently such as noise or insufficient charge.

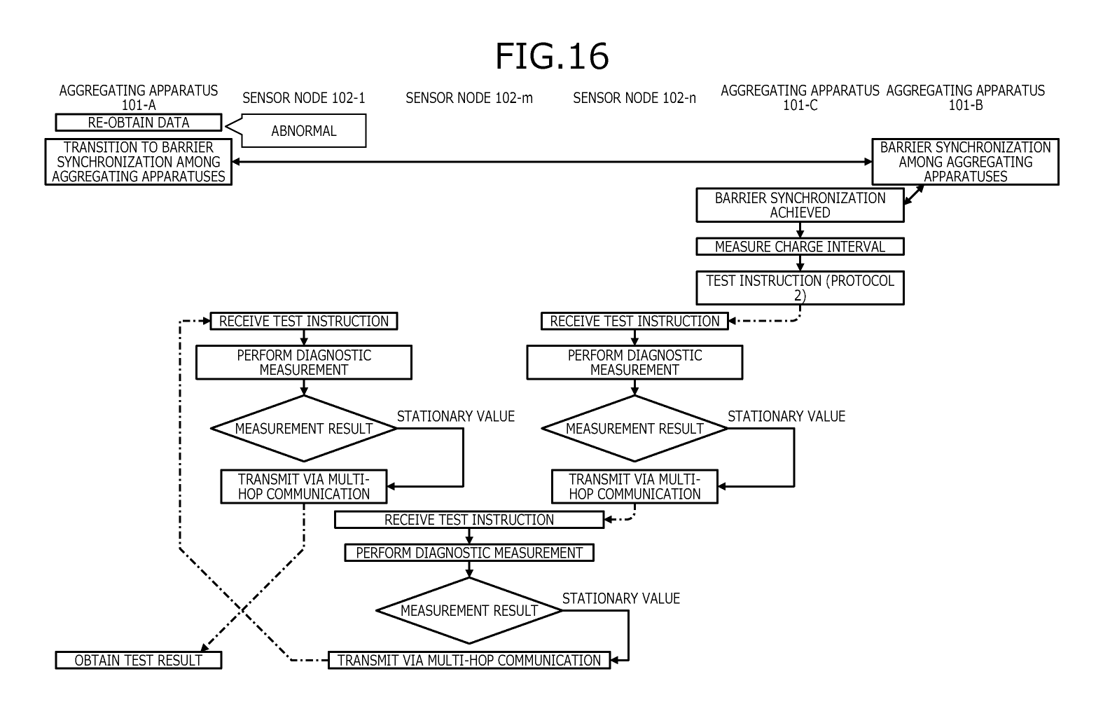

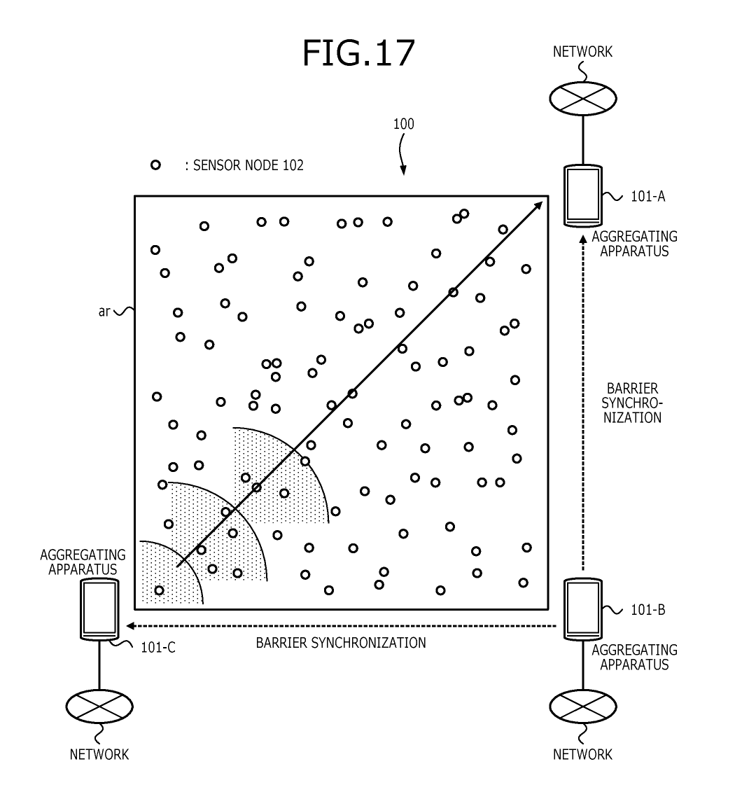

FIG. 16 is a diagram depicting a first example of the flow for testing after the communication paths have been determined to not correspond. FIG. 17 is a diagram depicting an example in which a test instruction is propagated. FIG. 16 depicts an example of communication by protocol 2. When the determining unit 603-A determines that an abnormality continues, the control unit 604-A performs barrier synchronization, and after standing by for the charging period after all of the aggregating apparatuses 101 have become synchronized, causes the aggregating apparatus 101 that transmitted the re-obtain_data instruction to transmit a test instruction. Further, in a case where the third communication path r3 and the fourth communication path r4 do not correspond, the control unit 604-A may perform barrier synchronization and after standing by for the charging period after all of the aggregating apparatuses 101 have synchronized, may cause the aggregating apparatus 101 that transmitted the re-obtain data instruction to transmit a test instruction. As described above, the aggregating apparatus 101-C transmitted the re-obtain_data instruction. It is possible that an instruction for the sensor nodes 102 may be being performed before the aggregating apparatuses 101 become synchronized. Therefore, standby for the charging period after synchronization enables the amount of charge of the battery 209 of each sensor node 102 to be an amount sufficient to execute each instruction.

The aggregating apparatus 101-C measures the charge interval and thereby, transmits the test instruction after standing by for the charging period. By propagating the test instruction by multi-hop communication, the sensor nodes 102 execute self-tests in response to the test instruction while propagating the test results to the aggregating apparatus 101.

More specifically, in the sensor nodes 102, when the receiving unit 501 receives the test instruction, the diagnosing unit 504 performs diagnostic measurement, whereby self-diagnosis is performed. As described, together with the test instruction, the receiving unit 501 obtains test results of other sensor nodes 102, multi-hopped from the aggregating apparatus 101. For example, the multi-hopped test results of other sensor nodes 102 are appended with the identification of the sensor node 102 passed and are arranged in the sequence passed.

In the sensor nodes 102, the judging unit 505 judges whether the diagnostic measurement result obtained by the diagnosing unit 504 is an erroneous value indicating failure. A case where the measurement result is not an erroneous value indicating failure is called a stationary value. In the example depicted in FIG. 16, the measurement results of the sensor nodes 102 are all stationary values. The aggregating apparatus 101 transmits to nearby sensor nodes 102, via multi-hop communication, the test result that is obtained by the judging unit 505 and to which the identification information of the sensor node 102 thereof is appended. Together with the test result, the aggregating apparatus 101 further transmits the test instruction received by the receiving unit 501 and the multi-hopped test results of other sensor nodes 102 to the nearby sensor nodes 102, via multi-hop communication.

The first obtaining unit 601-A obtains the test results by receiving the test results from the sensor nodes 102. The first obtaining unit 601-A obtains the test results from the sensor nodes 102 for the test instruction transmitted by the aggregating apparatus 101-C and propagated by multi-hop communication among the sensor nodes 102. More specifically, the first obtaining unit 601-A receives the test results from the sensor nodes 102 by multi-hop communication.

The determining unit 603-A determines based on the test results obtained by the first obtaining unit 601-A, whether a sensor node 102 has failed.

In the example depicted in FIG. 12, the aggregating apparatus 101-A, which has received test results for a test instruction by protocol 2, may transfer the re-obtained data to another aggregating apparatus 101 or a computer with which communication is possible. As a result, the aggregating apparatus 101-A may cause the other aggregating apparatus 101 or the other computer with which communication is possible to execute a process related to the abnormality determination by the functional units. Further, the aggregating apparatus 101-A, which has received the test results, may perform the process related to the abnormality determination, thereby enabling the process of transferring the test results to be omitted.

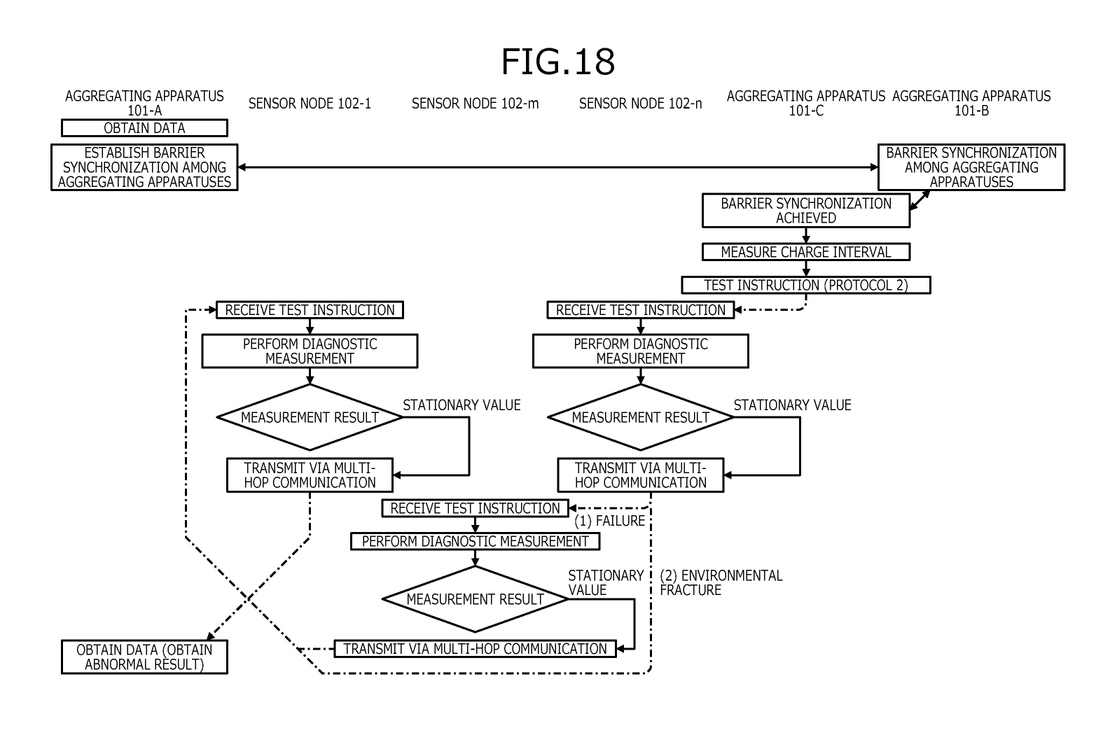

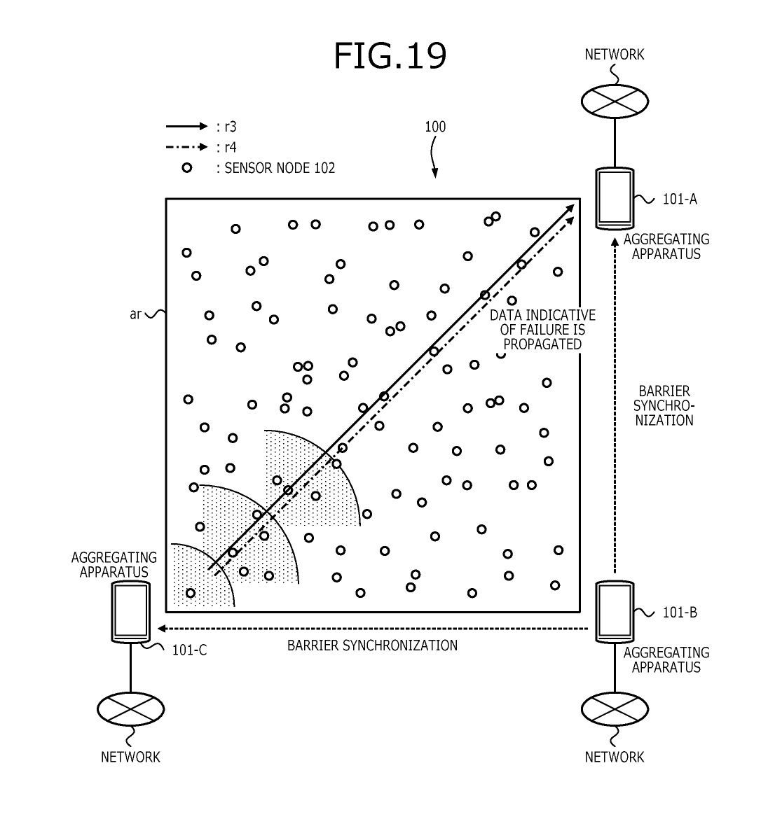

FIG. 18 is a diagram depicting a second example of the flow of testing after an abnormality has been determined. FIG. 19 is a diagram depicting an example in which test results at the time of failure are propagated. In the case of (1) in FIG. 18, at the sensor node 102-m, diagnostic measurement result is indicated to be an erroneous value and therefore, the determining unit 603-A judges that the test result for the sensor node 102-m indicates failure. As indicated by the propagation example depicted in FIG. 19, when the failure occurs at a sensor node 102, the sensor node 102 can transmit the test result for the test instruction and therefore, the communication path has a high possibility of being the same as during a normal state. Therefore, the determining unit 603-A judges whether information indicative of an erroneous value is present in the test result for the test instruction and is thereby, able to determine the presence of failure.

On the other hand, in the case of (2) in FIG. 18, at the sensor node 102-m, test instruction cannot be received from the sensor node 102-n. Therefore, the communication path from the aggregating apparatus 101-C that is the transmission source of the test instruction, to the aggregating apparatus 101-A that receives the test results by multi-hop communication differs from a normal case.

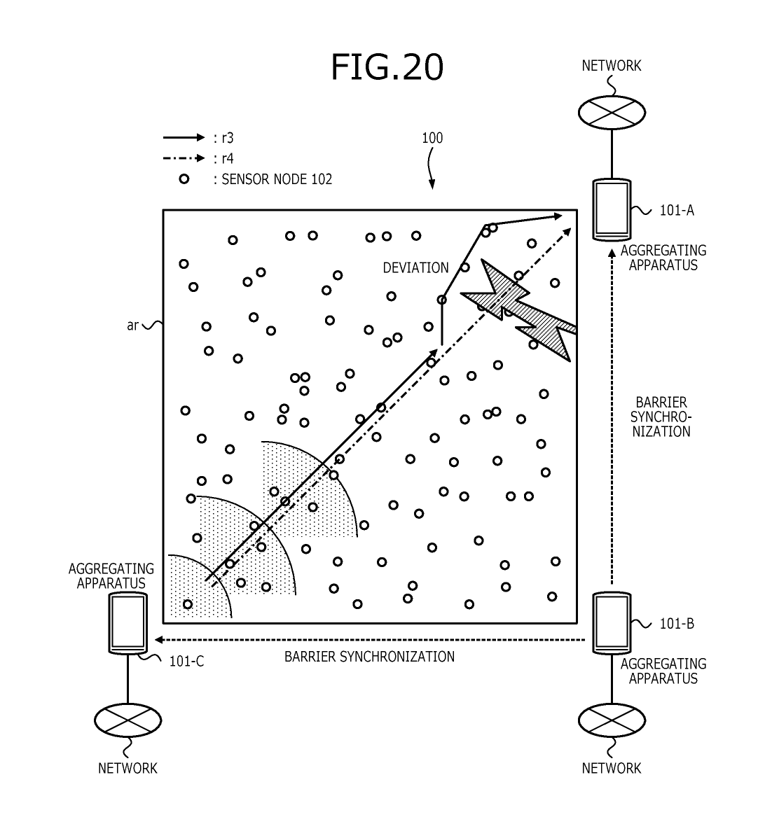

FIG. 20 is a diagram depicting an example in which a test instruction is propagated in a case where there is an abnormality in a positional relation. For example, if the environment in which the sensor nodes 102 are installed fractures, the positions of the sensor nodes 102 may shift, contact with a property to be sensed may be lost, etc. and abnormalities in positional relations among the sensor nodes 102 may occur. Therefore, the communication path from the aggregating apparatus 101-C that is the transmission source of the test instruction, to the aggregating apparatus 101-A that receives the test results by multi-hop communication is an alternate path.

Thus, the first obtaining unit 601-A obtains the third information related to the third communication path r3 that is from the aggregating apparatus 101-C to the aggregating apparatus 101-A. The third communication path r3 is a path from transmission of the test instruction by the aggregating apparatus 101-C to reception of test results by the aggregating apparatus 101-A, the test results being from the sensor nodes 102 in response to the test instruction propagated by multi-hop communication among the sensor nodes 102.

The second obtaining unit 602-A obtains from the storage apparatus 600, fourth information related to the fourth communication path r4. The fourth communication path r4 is a path from transmission of a signal by the aggregating apparatus 101-C to reception of the signal by the aggregating apparatus 101-A, the signal being propagated by multi-hop communication among the sensor nodes 102. For example, the fourth communication path r4 is a stationary communication path. Further, for example, when the aggregating apparatus 101 that transmitted a test instruction after transmitting a re-obtain_data instruction and transmitted a re-obtain_data instruction and the aggregating apparatus 101 that transmitted the test instruction are the same, the fourth communication path r4 may be the communication path at the time of transmission of the re-obtain_data instruction.

The determining unit 603-A compares the third information obtained by the first obtaining unit 601-A and the fourth information obtained by the second obtaining unit 602-A and thereby, judges whether the third communication path r3 and the fourth communication path r4 correspond. As a result, it can be judged whether an abnormality in the positional relation between a sensor node 102 and a nearby sensor node 102 has occurred. For example, if the third information and the fourth information do not correspond, the determining unit 603-A determines that the third communication path r3 and the fourth communication path r4 do not correspond. As a result, it can be determined that an abnormality in the positional relation between a sensor node 102 and a nearby sensor node 102 has occurred. On the other hand, for example, if the third information and the fourth information correspond, the determining unit 603-A determines that the third communication path r3 and the fourth communication path r4 correspond. As a result, it can be determined that no abnormality in the positional relation of a sensor node 102 and a nearby sensor node 102 has occurred.

Further, in the examples depicted in FIGS. 16 and 18, since failures and abnormalities in positional relations can be differentiated after the continuation of an abnormality related to a sensor node 102 has been determined by a re-obtain_data instruction, the aggregating apparatus 101 transmits the test instruction. Without limitation hereto, according to the example depicted in FIG. 10, after the first communication path r1 and the second communication path r2 have been determined to not correspond by the obtained data, the aggregating apparatus 101 before the re-obtain_data instruction may perform control transmission of the test instruction.

More specifically, for example, if the determining unit 603 determines that the first communication path r1 and the second communication path r2 do not correspond, the control unit 604 causes the aggregating apparatus 101 to transmit the test instruction. Alternatively, if the first communication path r1 and the second communication path r2 are determined to not correspond, the control unit 604 stands by for the charging period, which is the time consumed for charging of the sensor nodes 102, after the aggregating apparatus 101 transmits an obtain_data instruction. The control unit 604 may cause the test instruction to be transmitted by the aggregating apparatus 101 after standing by for the charging period.

Further, for example, the control unit 604 performs barrier synchronization among the aggregating apparatuses 101, after the determining unit 603 determines that the first communication path r1 and the second communication path r2 do not correspond. The control unit 604 causes the aggregating apparatus 101 that among the aggregating apparatuses 101, is last to become synchronized when barrier synchronization is achieved. As a result, after it has been determined that an abnormality is present by an obtain_data instruction by protocol 4, a test instruction by protocol 2 is transmitted before the transmission of an obtain_data instruction by protocol 1. Processes of the first obtaining unit 601, the second obtaining unit 602, and the determining unit 603 after the control by the control unit 604 are the same as those depicted in FIGS. 16 to 20 and therefore, detailed description is omitted here.

In the present embodiment, the system 100 can be built to detect even under limited conditions such as minimal charge of the battery 209 of a sensor node 102, whether the sensor node 102 can sense displacement related to the installation site.

Further, since fractures in the environment and/or failures of the sensor nodes 102 occur such that multi-hop communication among the sensor nodes 102 is not established and thus, sensing data does not reach an installed aggregating apparatus 101, the aggregating apparatuses 101 may not be able to perform barrier synchronization.

Further, as described, the timing at which the aggregating apparatuses 101 transmit a test instruction by protocol 3 or an obtain_data instruction by protocol 4, for example, may be specified by the user or may be at a constant interval. On the other hand, the re-obtain_data instruction by protocol 1 or the test instruction by protocol 2 transmitted by the aggregating apparatuses 101 may determine that an abnormality has occurred in the test instruction of protocol 3 or the obtain_data instruction of protocol 4.

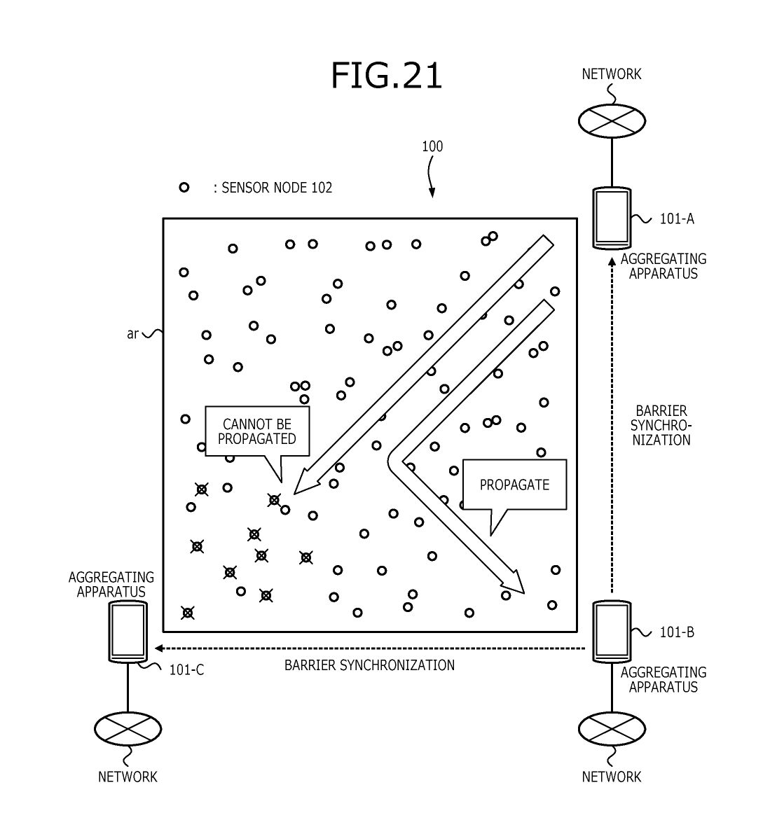

FIG. 21 is a diagram depicting an example in which there is no response for barrier synchronization. In FIG. 21, an x marked sensor node 102 is a sensor node 102 at which a failure has occurred, and if numerous sensor nodes 102 fail, instructions and/or results are not propagated to the aggregating apparatus 101-C. Therefore, the aggregating apparatus 101-C does not become synchronized to enable transition to the next protocol, even if synchronization notification is received. Thus, the control unit 604 controls the barrier synchronization while judging whether an aggregating apparatus 101 is present that does not enter a synchronized state even after a given period has elapsed since issuing the barrier synchronization among the aggregating apparatuses 101. When the aggregating apparatuses 101 are subject to barrier synchronization by the control unit 604, the determining unit 603 determines whether among the aggregating apparatuses 101, an aggregating apparatus 101 is present that is not synchronized even after a given period has elapsed since barrier synchronization was issued. If an aggregating apparatus 101 is present that does not become synchronized even after the given period has elapsed, the determining unit 603 determines that multi-hop communication among the sensor nodes 102 cannot be performed. The given period may be set by the designer of the system 100, based on past communication periods, or by may be defined by the user. In the example depicted in FIG. 21, the aggregating apparatus 101-C is not synchronized.

The aggregating apparatus 101 may notify the user that the measurement environment has been fractured. Alternatively, the aggregating apparatus 101 may output to the user, a message to adjust the distribution density of the sensor nodes 102 with respect to the measurement environment from an expected operation internal and node failure rate. For example, the aggregating apparatus 101 may again newly obtain information related the communication path and update the stored contents of the storage apparatus 600.

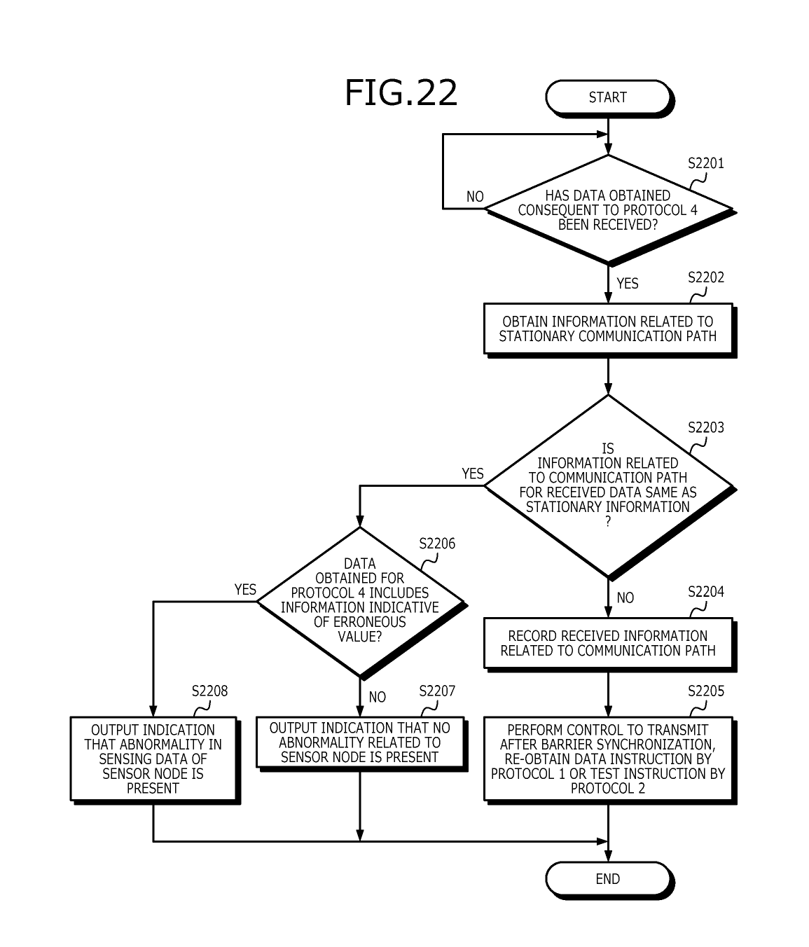

FIG. 22 is a flowchart depicting a first example of a procedure of a determining process by the aggregating apparatus. In the example depicted in FIG. 22, the obtained data is assumed to have information that is related to the communication path and that is the identification information of the passed sensor nodes 102, arranged in the sequence passed. The aggregating apparatus 101 judges whether data obtained consequent to protocol 4 has been received (step S2201). If data obtained consequent to protocol 4 has not been received (step S2201: NO), the aggregating apparatus 101 returns to step S2201. On the other hand, if data obtained consequent to protocol 4 has been received (step S2201: YES), the aggregating apparatus 101 obtains information related to the stationary communication path (step S2202).

The aggregating apparatus 101 judges whether information related to the communication path for the received data is the same as the stationary information (step S2203). If not (step S2203: NO), the aggregating apparatus 101 records the received information related to the communication path (step S2204). The aggregating apparatus 101 performs control to transmit after barrier synchronization, a re-obtain data instruction by protocol 1 or a test instruction by protocol 2 (step S2205), and ends the series of operations.

If the received data and the stationary information are the same (step S2203: YES), the aggregating apparatus 101 judges whether the data obtained for protocol 4 includes information indicative of an erroneous value (step S2206). If no information indicative of an erroneous value is included (step S2206: NO), the aggregating apparatus 101 outputs indication that there is no abnormality related to a sensor node 102 (step S2207), and ends the series of operations. If information indicative of an erroneous value is included (step S2206: YES), the aggregating apparatus 101 outputs indication that there is an abnormality in the sensing data of a sensor node 102 (step S2208), and ends the series of operations.

In the flowchart depicted in FIG. 22, although determination of whether information indicative of an erroneous value is included is made after the determination concerning the communication path, configuration is not limited hereto, and the determination concerning the communication path may be made after the determination of whether information indicative of an erroneous value is included.

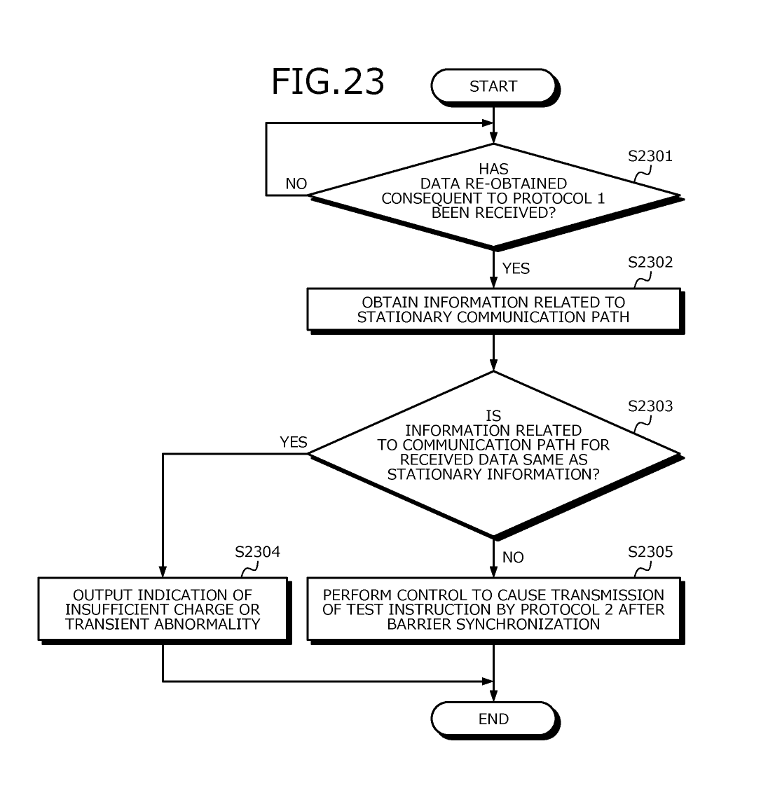

FIG. 23 is a flowchart depicting a second example of a procedure of the determining process by the aggregating apparatus. In the example depicted in FIG. 23, the re-obtained data is assumed to have information that is related to the communication path and that is the identification information of the passed sensor nodes 102, in the sequence passed. The aggregating apparatus 101 judges whether data re-obtained consequent to protocol 1 has been received (step S2301). If no data re-obtained consequent to protocol 1 has been received (step S2301: NO), the aggregating apparatus 101 returns to step S2301. On the other hand if data re-obtained consequent to protocol 1 has been received (step S2301: YES), the aggregating apparatus 101 obtains information related to the stationary communication path (step S2302).

The aggregating apparatus 101 judges whether the information related to the communication path for the received data is the same as the stationary information (step S2303). If so (step S2303: YES), the aggregating apparatus 101 outputs indication of insufficient charge or a transient abnormality (step S2304), and ends the series of operations. If not (step S2303: NO), the aggregating apparatus 101 performs control to cause transmission of a test instruction by protocol 2 after barrier synchronization (step S2305), and ends the series of operations.

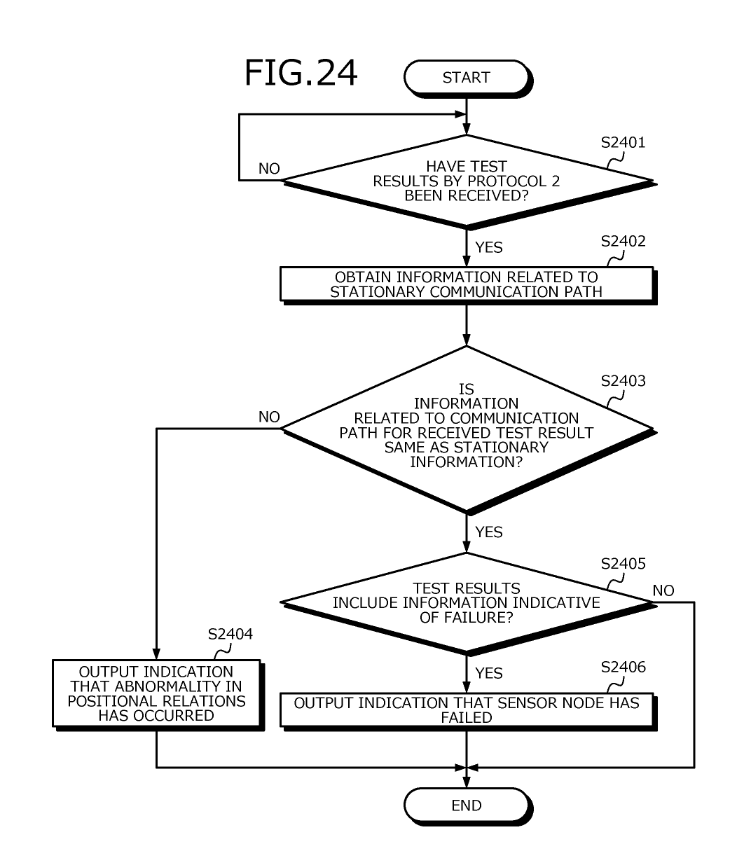

FIG. 24 is a flowchart depicting a third example of a procedure of the determining process by the aggregating apparatus. In the example depicted in FIG. 24, the test results are assumed to have information that is related to the communication path and that is the identification information of the passed sensor nodes 102, in the sequence passed. The aggregating apparatus 101 judges whether test results by protocol 2 have been received (step S2401). If no test results by protocol 2 have been received (step S2401: NO), the aggregating apparatus 101 returns to step S2401. On the other hand, if test results by protocol 2 have been received (step S2401: YES), the aggregating apparatus 101 obtains information related to the stationary communication path (step S2402).

The aggregating apparatus 101 judges whether the information related to the communication path for the received test result is the same as the stationary information (step S2403). If not (step S2403: NO), the aggregating apparatus 101 outputs indication that an abnormality in positional relations has occurred (step S2404), and ends the series of operations.

If the information related to the communication path for the test result is the same as the stationary information (step S2403: YES), the aggregating apparatus 101 judges whether the test results includes information indicative of failure (step S2405). If the test results do not include information indicative of failure (step S2405: NO), the aggregating apparatus 101 ends the series of operations. If the test result includes information indicative of failure (step S2405: YES), the aggregating apparatus 101 outputs indication that a sensor node 102 has failed (step S2406), and ends the series of operations.

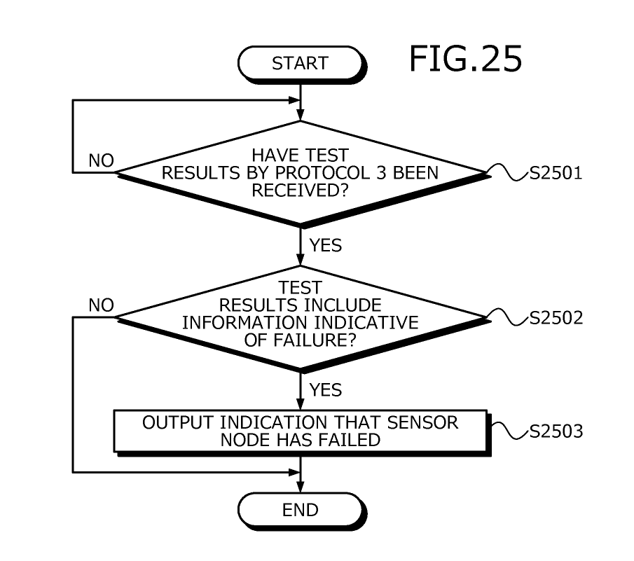

FIG. 25 is a flowchart depicting a fourth example of a procedure of the determining process by the aggregating apparatus. In the example depicted in FIG. 25, the test results are assumed to have information that is related to the communications path and that is the identification information of the passed sensor nodes 102, in the sequence passed. The aggregating apparatus 101 judges whether test results by protocol 3 have been received (step S2501). If no test results by protocol 3 have been received (step S2501: NO), the aggregating apparatus 101 returns to step S2501. If test results by protocol 3 have been received (step S2501: YES), the aggregating apparatus 101 judges whether the test results include information indicative of failure (step S2502). If the test results include no information indicative of failure (step S2502: NO), the aggregating apparatus 101 ends the series of operations. If the test results include information indicative of failure (step S2502: YES), the aggregating apparatus 101 outputs indication that a sensor node 102 has failed (step S2503), and ends the series of operations.

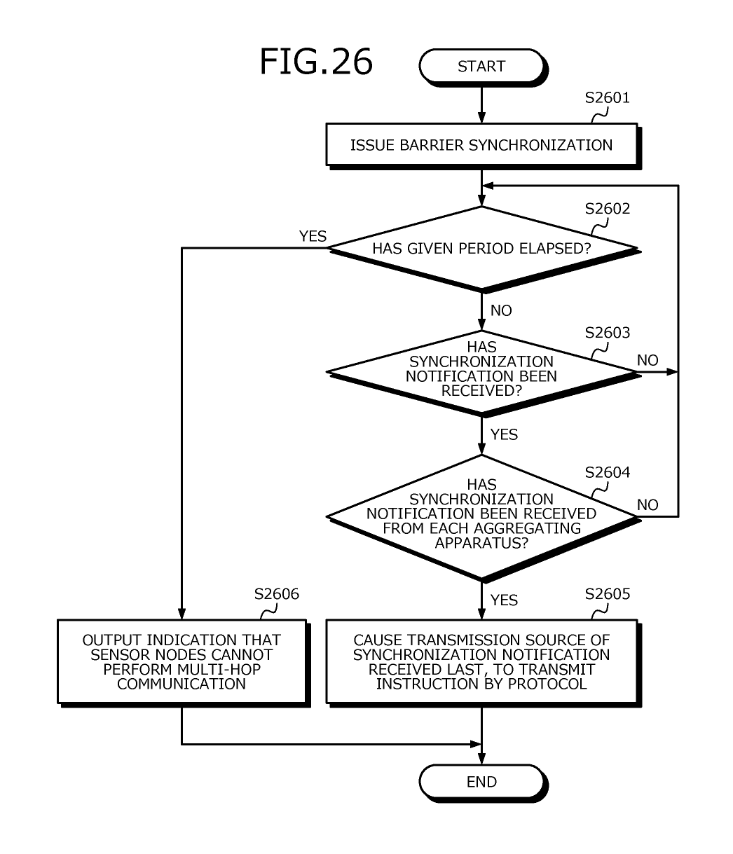

FIG. 26 is a flowchart depicting an example of a procedure of the barrier synchronization process by the aggregating apparatuses. The aggregating apparatus 101 issues barrier synchronization (step S2601), and judges whether a given period has elapsed since issuing barrier synchronization (step S2602). If the given period has not elapsed (step S2602: NO), the aggregating apparatus 101 judges whether synchronization notification has been received from another aggregating apparatus 101 (step S2603). If no synchronization notification has been received from another aggregating apparatus 101 (step S2603: NO), the aggregating apparatus 101 returns to step S2602.

If synchronization notification has been received from another aggregating apparatus 101 (step S2603: YES), the aggregating apparatus 101 judges whether synchronization notification has been received from each of the aggregating apparatuses 101 (step S2604). If synchronization notification has not been received from each of the aggregating apparatuses 101 (step S2604: NO), the aggregating apparatus 101 returns to step S2602. If synchronization notification has been received from each of the aggregating apparatuses 101 (step S2604: YES), the aggregating apparatus 101 causes the transmission source of the synchronization notification received last, to transmit an instruction by a protocol (step S2605), and ends the series of operations.

At step S2602, if the given period has elapsed since issuing barrier synchronization (step S2602: YES), the aggregating apparatus 101 outputs indication that the sensor nodes 102 cannot perform multi-hop communication (step S2606), and ends the series of operations.

As described above, the computer determines whether the first communication path, which is from transmission of a transmission instruction by a first aggregating apparatus, to reception (by a second aggregating apparatus) of a transmission signal in response to the transmission instruction multi-hopped among nodes, and the second communication path of a normal state correspond. As a result, even if a response from a communication node is not returned to the communications apparatus that instructed signal transmission, it can be determined whether an abnormality related to a communications node among sensor nodes is present.

Further, the computer determines whether the third communication path, which is from transmission (by a third aggregating apparatus) of a test instruction causing the sensor nodes to perform a self-test, to reception by a fourth aggregating apparatus, via multi-hop communication among the sensor nodes, and the fourth communication path of a normal state correspond. Here, a test instruction, which is qualitatively different from a transmission instruction instructing sensor data to be obtained, is propagated. If the two communication paths do not correspond, the computer can determine that the positional relation of a sensor node and another sensor node at the time of communication has changed, or that the test instruction cannot be received consequent to the battery being charged. Therefore, it can be determined that an abnormality such as the shifting of the position of a sensor node has occurred, or that the battery is being charged. On the other hand, if the communication paths at the time of transmission of the test instruction correspond, it can be determined that a sensor node has failed, or that response is not possible consequent to a transient abnormality, sensing being performed, the battery being charged, etc. at the time of the transmission instruction.

Further, if the test instruction is transmitted after a re-obtain_data instruction has been transmitted, and the aggregating apparatus 101 that transmitted the re-obtain_data instruction is the same aggregating apparatus 101 that transmitted the test instruction, the computer may regard the fourth communication path to be the communication path at the time when the re-obtain_data instruction is transmitted.

The computer transmits the test instruction after standing by for the charging period and makes a determination concerning the communication path of the test results for the test instruction. As a result, since the computer stands by for the charging period, the charging of the sensor nodes is completed and therefore, if the communication paths do not correspond, it can be determined that the positional relation between a sensor node and another sensor node at the time of communication has changed.

The computer determines after the transmission of the test instruction, whether the second communication path and the third communication path correspond and further determines whether test results indicate failure. As a result, if the communication path of the test results corresponds with the stationary communication path, it can be determined whether an abnormality in the obtaining of data consequent to failure has been detected. Accordingly, the accuracy of the determination can be improved.

If the first communication path and the second communication path do not correspond, the computer implements barrier synchronization before causing the third communications apparatus to transmit the test instruction. As a result, among the sensor nodes, propagation of the test instruction related to abnormality determination can be prevented from being hindered by the propagation of another instruction. Accordingly, the accuracy of the determination can be improved.

The computer causes the third communications apparatus to transmit the test instruction after standing by for the charging period after all of the aggregation apparatuses have been synchronized by barrier synchronization. As a result, since the charging of all of the sensor nodes is allowed to be completed after an aggregating apparatus lastly transmits an instruction to the sensor nodes, the occurrence of abnormalities consequent to the sensor nodes being charged can be prevented. Accordingly, the accuracy of the determination can be improved.

The computer causes the aggregating apparatus that is last to synchronize by barrier synchronization to transmit the test instruction, as the third aggregating apparatus. As a result, among the communications apparatuses, the communications apparatus that is to transmit the test instruction is predetermined and thus, the process of determining the communications apparatus can be omitted at the time of communication.

If the second communications apparatus, which received the transmission signal for the transmission instruction, executes the processing of the computer to determine whether the first communication path and the second communication path correspond, the process of causing the received data to be transferred to another computer can be omitted.

If the first communication path and the second communication path do not correspond, after standing by for the charging period, the computer causes the third aggregating apparatus to transmit a second transmission instruction instructing the retransmission of sensing data. The computer determines the correspondence of the third communication path that is from the third aggregating apparatus to the fourth aggregation apparatus that receives a second transmission signal for the second transmission instruction, and the fourth communication path of a normal state. As a result, if the communication paths correspond, it can be determined that the first communication path differed from the second communication path of the normal state consequent to a transient abnormality, charging, or a sensor in the progress of responding.

If the first communication path and the second communication path do not correspond, the computer implements barrier synchronization before causing the third communications apparatus to transmit the second transmission signal. As a result, the propagation of the test instruction among the sensor nodes can be prevented from being hindered by the propagation of another instruction. Accordingly, the accuracy of the determination can be improved.

The computer causes the third communications apparatus to transmit the second transmission signal after standing by for the charging period after all of the aggregating apparatuses have been synchronized by barrier synchronization. As a result, since the charging of all of the sensor nodes is allowed to be completed after an aggregating apparatus lastly transmits an instruction to the sensor nodes, the occurrence of abnormalities consequent to the sensor nodes being charged can be prevented. Accordingly, the accuracy of the determination can be improved.

If the first communication path and the second communication path do not correspond, the third communications apparatus that transmits the test instruction or the second transmission signal is the apparatus that is last to synchronize by barrier synchronization. As a result, among the communications apparatuses, the communications apparatus that is to transmit the test instruction or the second transmission signal is predetermined and thus, the process of determining the communications apparatus can be omitted at the time of communication.

The second communications apparatus, which receives a transmission signal for the transmission instruction, executes the processing of the computer to determine whether the first communication path and the second communication path correspond. The fourth communications apparatus, which receives test results for the test instruction or a transmission signal for the second transmission instruction, executes processing of the computer to determine whether the third communication path and the fourth communication path correspond. As a result, the process of causing the received data to be transferred to another computer can be omitted.

If a communications apparatus is present that has not synchronized despite the given period elapsing after issuance of barrier synchronization, the computer determines that multi-hop communication cannot be performed by the sensor node. As a result, widespread failure of the sensor nodes installed in the installation area can be detected and breakdown of the system can be determined. Consequently, the user can redesign the system according to the determination result.

After determination that an abnormality related to a sensor node consequent to protocol 4 is present, that protocol that is to be transmitted first among protocol 2 and protocol 1 is assumed to be predefined in the system by the designer or the user of the system. Further, after determination that an abnormality related to a sensor node consequent to protocol 3 is present, protocol 2 or protocol 1 may be transmitted and the type of abnormality may be identified.

According to one aspect of the embodiment, an abnormality related to a communications node can be determined.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A determining method that is executed by a computer having a storage device storing therein information, the determining method comprising:
writing to the storage device, first information related to a first communication path that is from a first communications apparatus to a second communication apparatus when the second communications apparatus, which is different from the first communications apparatus, receives a transmission signal that is from a plurality of communications nodes and in response to a transmission instruction that is transmitted by the first communications apparatus and propagated by multi-hop communication among the plurality of communications nodes;
writing to the storage device, second information related to a second communication path that is from transmission of a signal by the first communications apparatus after the writing of the first information to the storage device, to reception by the second communications apparatus, of the signal propagated by multi-hop communication among the plurality of communications nodes; and
determining based on a comparison result of the first information and the second information read from the storage device, correspondence of the first communication path and the second communication path.

2. The determining method according to claim 1, wherein the transmission instruction is a transmission instruction for the plurality of communications nodes to transmit sensing data of a sensor provided in each communications node,
the computer further executes:
performing upon determining that the first communication path and the second communication path do not correspond, control to cause a third communications apparatus to transmit a test instruction causing the plurality of communications nodes to respectively perform a self-test;
obtaining third information related to a third communication path that is from the third communications apparatus to a fourth communications apparatus when the fourth communications apparatus, which is different from the third communications, receives a test result that is from the plurality of communications nodes and propagated by multi-hop communication among the plurality of communications nodes in response to the test instruction that is transmitted by the third communications apparatus and propagated by multi-hop communication among the plurality of communications nodes;
obtaining fourth information that is stored in the storage apparatus and related to a fourth communication path that is from transmission of a signal by the third communications apparatus, to reception by the fourth communications apparatus, of the signal propagated by the multi-hop communication among the plurality of communications nodes; and
determining by comparison of the obtained third information and the obtained fourth information, correspondence of the third communication path and the fourth communication path.

3. The determining method according to claim 2, wherein
the performing of control to cause the third communications apparatus to transmit the test instruction includes when the first communication path and the second communication path do not correspond, causing the third communications apparatus to transmit the test instruction after standing by for a charging period consumed for charging the plurality of communications nodes, after the second communications apparatus receives the transmission signal.

4. The determining method according to claim 2, wherein
the computer executes:
obtaining the test result; and
determining based on the obtained test result,
whether a communications node among the plurality of communications nodes has a failure.

5. The determining method according to claim 2, wherein
the computer upon determining that the first communication path and the second communication path do not correspond, executes
processing to perform control to establish barrier synchronization among a plurality of communications apparatuses capable of communicating with the plurality of communications nodes and including at least the first communications apparatus and the second communications apparatus.

6. The determining method according to claim 5, wherein
the processing to perform control to cause the third communications apparatus to transmit the test instruction includes causing the third communications apparatus to transmit the test instruction after standing by for a charging period consumed for charging the plurality of communications nodes, after each communications apparatus among the plurality of communications apparatuses has become synchronized.

7. The determining method according to claim 5, wherein
the processing to perform control to cause the third communications apparatus to transmit the test instruction includes causing the third communications apparatus, which is last among the plurality of communications apparatus to be synchronized by the barrier synchronization, to transmit the test instruction.

8. The determining method according to claim 1, wherein
the computer is the second communications apparatus.

9. The determining method according to claim 1, wherein
the computer executes:
upon determining that first communication path and the second communication path do not correspond, performing control to cause a second transmission instruction to be transmitted to the plurality of communications nodes by a third communications apparatus after standing by for a charging period consumed for charging of the plurality of communications nodes, after the second communications apparatus has received the transmission signal;
obtaining and storing to the storage device, third information that is related to a third communication path that is from the third communications apparatus to a fourth communications apparatus when the fourth communications apparatus, which is different from the third communications apparatus, receives by multi-hop communication among the plurality of communications nodes, a second transmission signal that is from the plurality of communications nodes in response to the second transmission instruction that is transmitted by the third communications apparatus and propagated by multi-hop communication among the plurality of communications nodes;
obtaining and writing to the storage device, fourth information that is related to a fourth communication path that is from transmission of a signal by the third communications apparatus, to reception by the fourth communications apparatus, of the signal propagated by multi-hop communication among the plurality of communications nodes; and
determining by comparison of the third information read from the storage device and the fourth information read from the storage device, whether the third communication path and the fourth communication path correspond.

10. The determining method according to claim 9, wherein
the computer upon determining that the first communication path and the second communication path do not correspond, executes
processing to perform control to establish barrier synchronization among a plurality of communications apparatuses capable of communicating with the plurality of communications nodes and including at least the first communications apparatus and the second communications apparatus.

11. The determining method according to claim 10, wherein
the processing to perform control to cause the second transmission instruction to be transmitted by the third communications apparatus includes causing the second transmission instruction to be transmitted by the third communications apparatus after standing by for a charging period consumed for charging the plurality of communications nodes, after each communications apparatus among the plurality of communications apparatuses has become synchronized.

12. The determining method according to claim 10, wherein
the processing to perform control to cause the second transmission instruction to be transmitted by the third communications apparatus includes causing the second transmission instruction to be transmitted by the third communications apparatus, which is last among the plurality of communications apparatuses to be synchronized by the barrier synchronization.

13. The determining method according to claim 3, wherein
the computer includes a computer provided in the second communications apparatus and a computer provided in the fourth communications apparatus,
the computer provided in the second communications apparatus executes:
obtaining the first information,
obtaining the second information,
determining correspondence of the first communication path and the second communication path, and
performing control to cause the test instruction to be transmitted by the third communications apparatus; and
the computer provided in the fourth communications apparatus executes:
obtaining the third information,
obtaining the fourth information, and
determining correspondence of the third communication path and the fourth communication path.

14. The determining method according to claim 9, wherein
the computer includes a computer provided in the second communications apparatus and a computer provided in the fourth communications apparatus,
the computer provided in the second communications apparatus executes:
obtaining the first information,
obtaining the second information,
determining correspondence of the first communication path and the second communication path, and
performing control to cause the second transmission instruction to be transmitted by the third communications apparatus; and
the computer provided in the fourth communications apparatus executes:
obtaining the third information,
obtaining the fourth information, and
determining correspondence of the third communication path and the fourth communication path.

15. The determining method according to claim 5, wherein
the computer determines that multi-hop communication among the plurality of communications nodes is not possible, when the barrier synchronization is implemented among the plurality of communications apparatuses and a communications apparatus among the plurality of communications apparatuses does not become synchronized despite a given period elapsing since implementation of the barrier synchronization.

16. A system comprising:
a plurality of communications nodes;
a first communications apparatus capable of communicating with the plurality of communication nodes; and
a second communications apparatus that is capable of communicating with the plurality of communications nodes and is different from the first communications apparatus, wherein
the second communications apparatus:
has a storage apparatus storing therein information,
obtains and writes to the storage apparatus, first information related to a first communication path that is from the first communications apparatus to the second communications apparatus when by multi-hop communication among the communications nodes, the second communications apparatus receives a transmission signal that is from the plurality of communications nodes in response to a transmission instruction that is transmitted by the first communications apparatus and propagated by multi-hop communication among the plurality of communications nodes,
obtains and writes to the storage apparatus, second information related to a second communication path that is from transmission of a signal by the first communications apparatus, to reception by the second communications apparatus, of the signal propagated by multi-hop communication among the plurality of communications nodes,
determines by comparison of the obtained first information and the obtained second information, correspondence of the first communication path and the second communication path.
